(19) United States
(12) Patent Application Publication
(10) Pub. No.: US 2018/0106961 A1
(43) Pub. Date: Apr. 19, 2018

(54) BACKLIGHT UNIT

(71) Applicant: SAMSUNG DISPLAY CO., LTD., Yongin-si (KR)

(72) Inventors: Seongyong HWANG, Hwaseong-si (KR); Woojong SON, Seoul (KR); Sungyong KANG, Asan-si (KR); Byungseo YOON, Hwaseong-si (KR); Sanghoon LEE, Hwaseong-si (KR); Kyunghoon CHAE, Hwaseong-si (KR)

(21) Appl. No.: 15/785,867

(22) Filed: Oct. 17, 2017

(30) Foreign Application Priority Data
Oct. 17, 2016 (KR) 10-2016-0134482

(51) Int. Cl. F21V 8/00

(52) U.S. Cl. CPC G02B 6/0088; G02B 6/0053; G02B 6/0051; G02B 6/009

(57) ABSTRACT

A backlight unit includes a support frame between a base portion of a bottom case and a display panel, a light guide plate between the base portion of the bottom case and the support frame, a light source between the light guide plate and a side portion of the bottom case protruding from the base portion of the bottom case, and a first optical sheet between the support frame and the display panel.

This application claims priority to Korean Patent Application No. 10-2016-0134482, filed on Oct. 17, 2016, and all the benefits accruing therefrom under 35 U.S.C. § 119, the content of which in its entirety is herein incorporated by reference.

### BACKGROUND

### 1. Technical Field

Exemplary embodiments of the invention relate to a backlight unit, and more particularly, to a backlight unit capable of reducing a thickness of a display device and a width of a bezel area.

### 2. Discussion of Related Art

A liquid crystal display (“LCD”) device is a-type of a flat panel display (“FPD”) device which has found widespread applications. In general, the LCD device includes two substrates including field-generating electrodes, e.g., a pixel electrode and a common electrode, and a liquid crystal layer interposed therebetween. Upon applying voltage to the field-generating electrodes, liquid crystal molecules of the liquid crystal layer are rearranged such that an amount of transmitted light is controlled in the LCD device.

Such an LCD device includes a backlight unit. The backlight unit is classified into a direct-type backlight unit, an edge-type backlight unit and a corner-type backlight unit according to the position of a light source.

### SUMMARY

Exemplary embodiments according to the invention are directed to a backlight unit that has advantages of a direct-type backlight unit and advantages of an edge-type backlight unit.

According to an exemplary embodiment, a backlight unit includes a support frame between a base portion of a bottom case and a display panel, a light guide plate between the base portion of the bottom case and the support frame, a light source between the light guide plate and a side portion of the bottom case protrudes from the base portion of the bottom case, and a first optical sheet between the support frame and the display panel.

In an exemplary embodiment, the backlight unit may further include a second optical sheet between the light guide plate and the support frame.

In an exemplary embodiment, the second optical sheet may include a film, a plurality of diffusers on the film, the plurality of diffusers having different refractive indices, and an adhesive between the diffusers and the film and between adjacent ones of the diffusers.

In an exemplary embodiment, the plurality of diffusers may have a sphere shape and have different diameters.

In an exemplary embodiment, the second optical sheet may include a film and a plurality of lens patterns on the film.

In an exemplary embodiment, at least one lens pattern of the plurality of lens patterns may have a hemispherical shape or a triangular prism shape.

In an exemplary embodiment, the second optical sheet may include a film and a plurality of diffusers in the film, where the plurality of diffusers has different refractive indices.

In an exemplary embodiment, the second optical sheet may include a quantum dot or a quantum rod.

In an exemplary embodiment, the first optical sheet may include a plurality of sheets, where each of the plurality of sheets is positioned at a different distance from the display panel, from each other.

In an exemplary embodiment, at least one sheet of the plurality of sheets may further include a fastening portion which protrudes from an edge of the at least one sheet and has a fastening hole.

In an exemplary embodiment, the at least one sheet may include a sheet that is adjacent to the support frame or the display panel among the plurality of sheets.

In an exemplary embodiment, the support frame may include a fastening groove into which the fastening portion is inserted and a fastening projection inserted to the fastening hole of the fastening portion.

In an exemplary embodiment, an angle between an inner side surface of the support frame and the first optical sheet may be an acute angle.

In an exemplary embodiment, an angle between the inner side surface of the support frame and the first optical sheet may be from about 60 degrees to about 80 degrees.

In an exemplary embodiment, the support frame may have a trapezoidal cross-section having one hypotenuse, and an angle between the hypotenuse and the first optical sheet may be the same as the angle between the inner side surface of the support frame and the first optical sheet.

In an exemplary embodiment, the support frame may include a horizontal portion which overlaps the light source and an edge of the light guide plate and a vertical portion which protrudes from the horizontal portion toward the first optical sheet.

In an exemplary embodiment, the vetical portion, an overlap portion of the horizontal portion, which overlaps the vetical portion, and a non-overlap portion of the horizontal portion, which does not overlaps the vetical portion, may have different light transmittances.

In an exemplary embodiment, the non-overlap portion of the horizontal portion may have a higher light transmittance than a light transmittance of the overlap portion of the horizontal portion.

In an exemplary embodiment, the support frame may include a plurality of inner side surfaces having different slopes and an angle between each of the inner side surfaces and the first optical sheet may be an acute angle.

In an exemplary embodiment, the support frame may have a white color.

The foregoing is illustrative only and is not intended to be in any way limiting. In addition to the illustrative aspects, exemplary embodiments and features described above, further aspects, exemplary embodiments and features will become apparent by reference to the drawings and the following detailed description.

### BRIEF DESCRIPTION OF THE DRAWINGS

A more complete appreciation according to the invention will become more apparent by describing in detail exemplary embodiments thereof with reference to the accompanying drawings, wherein:

FIG. 1 is an exploded perspective view illustrating an exemplary embodiment of a display device including a backlight unit according to the invention;

FIG. 2 is a cross-sectional view taken along line I-I′ of FIG. 1;

FIG. 3A is a perspective view illustrating an exemplary embodiment of a second optical sheet of FIG. 1;

FIG. 3B is a cross-sectional view taken along line I-I′ of FIG. 3A;

FIG. 4A is a perspective view illustrating another exemplary embodiment of the second optical sheet of FIG. 1;

FIG. 4B is a cross-sectional view taken along line I-I′ of FIG. 4A;

FIG. 5A is a perspective view illustrating still another exemplary embodiment of the second optical sheet of FIG. 1;

FIG. 5B is a cross-sectional view taken along line I-I′ of FIG. 5A;

FIG. 6A is a perspective view illustrating still another exemplary embodiment of the second optical sheet of FIG. 1;

FIG. 6B is a cross-sectional view taken along line I-I′ of FIG. 6A;

FIG. 7 is an explanatory view illustrating an exemplary embodiment of an optical path of a light passing through the second optical sheet of FIG. 4A;

FIG. 8 is an explanatory view illustrating an exemplary embodiment of the coupling relationship between the first optical sheet and the support frame of FIG. 1;

FIG. 9 is a cross-sectional view taken along line I-I′ of FIG. 8;

FIG. 10 is an explanatory view illustrating an exemplary embodiment of the coupling relationship between a support frame and an optical sheet, a light collimation sheet, and a protective sheet, when the optical sheet, the light collimation sheet and the protective sheet being included in the first optical sheet;

FIG. 11 is a cross-sectional view of another exemplary embodiment taken along line I-I′ of FIG. 1;

FIG. 12 is an exploded perspective view illustrating another exemplary embodiment of a display device including a backlight unit according to the invention;

FIG. 13 is a cross-sectional view taken along line I-I′ of FIG. 12;

FIG. 14 is an exploded perspective view illustrating still another exemplary embodiment of a display device including a backlight unit according to the invention;

FIG. 15 is a cross-sectional view illustrating an exemplary embodiment taken along line I-I′ of FIG. 14;

FIG. 16 is a cross-sectional view illustrating another exemplary embodiment taken along line I-I′ of FIG. 14;

FIG. 17 is a view illustrating still another exemplary embodiment of a display device including a backlight unit according to the invention;

FIG. 18 is a cross-sectional view taken along line I-I′ of FIG. 17;

FIG. 19 is an exploded perspective view illustrating still another exemplary embodiment of a display device including a backlight unit according to the invention;

FIG. 20 is a cross-sectional view taken along line I-I′ of FIG. 19;

FIG. 21 is an exploded perspective view illustrating still another exemplary embodiment of a display device including a backlight unit according to the invention;

FIG. 22 is a cross-sectional view taken along line I-I′ of FIG. 21;

FIGS. 23A and 23B are explanatory views illustrating exemplary embodiments of optical paths depending on the presence of a second optical sheet;

FIG. 24A is a view illustrating luminance distribution at an edge portion of a display panel of FIG. 23A;

FIG. 24B is a view illustrating luminance distribution at an edge portion of a display panel of FIG. 23B;

FIG. 25 is a graph showing luminance at the display panel versus a distance from an edge of the display panel of FIG. 23A and of FIG. 23B; and

FIG. 26 is a graph showing luminance at the display panel depending on an angle between an inner side surface and a lower surface of a support frame of FIG. 2 versus a distance from an edge of a display panel.

### DETAILED DESCRIPTION

Exemplary embodiments will now be described more fully hereinafter with reference to the accompanying drawings. Although the invention may be modified in various manners and have several exemplary embodiments, exemplary embodiments are illustrated in the accompanying drawings and will be mainly described in the specification. However, the scope of the invention is not limited to the exemplary embodiments and should be construed as including all the changes, equivalents and substitutions included in the spirit and scope of the invention.

In the drawings, thicknesses of a plurality of layers and areas are illustrated in an enlarged manner for clarity and ease of description thereof. When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “lower”, “above”, “upper” and the like may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements and/or components, but do not preclude the presence or addition of one or more other features, integers, steps, operations, elements, components and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Some of the parts which are not associated with the description may not be provided in order to for example describe exemplary embodiments according to the invention and like reference numerals refer to like exemplary elements throughout the specification.

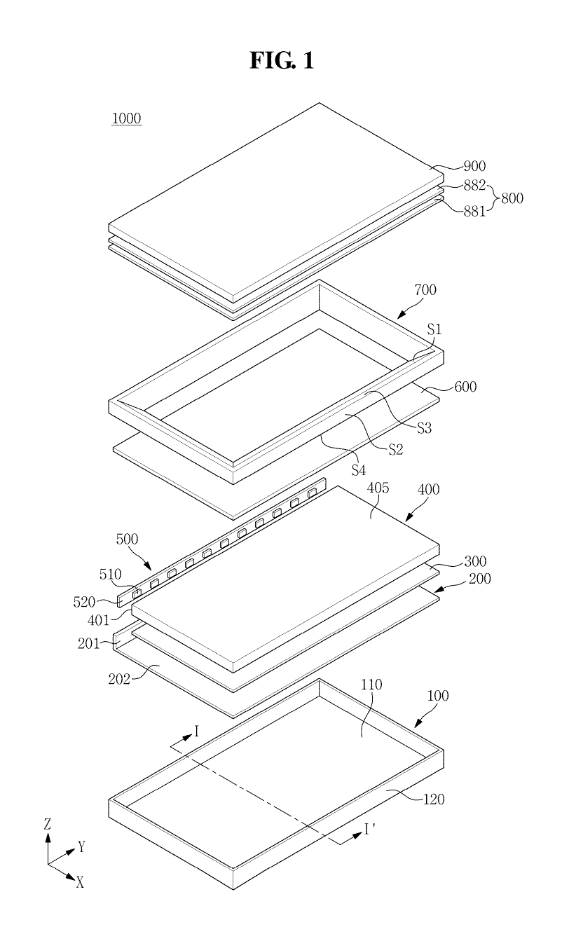

Hereinafter, an exemplary embodiment of a backlight unit according to the invention will be described in detail with reference to FIGS. 1 to 26.

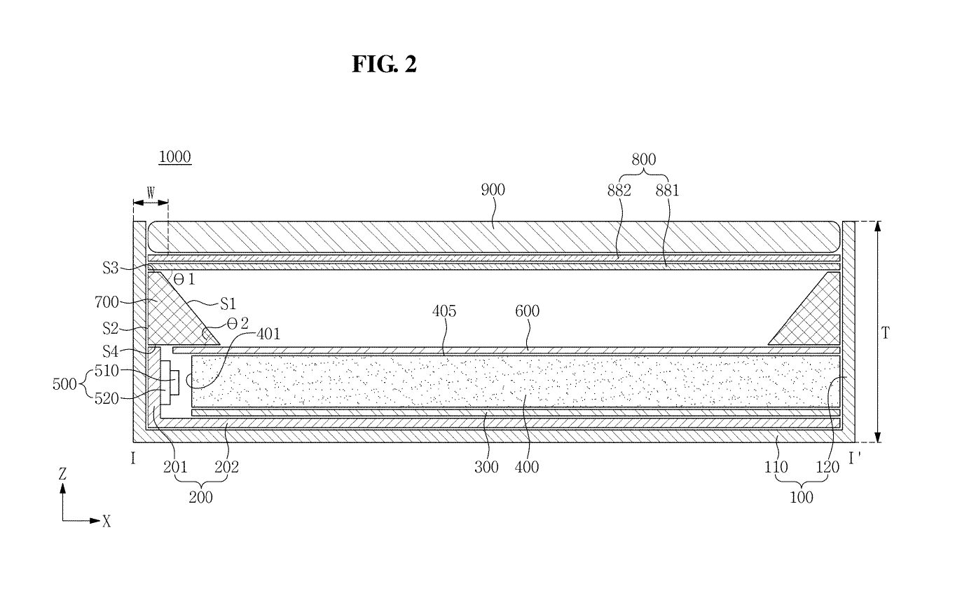

FIG. 1 is an exploded perspective view illustrating an exemplary embodiment of a display device 1000 including a backlight unit according to the invention, and FIG. 2 is a cross-sectional view taken along line I-I′ of FIG. 1.

The display device 1000 according to an exemplary embodiment includes a bottom case 100, a heat dissipation plate 200, a reflective sheet 300, a light source module 500, a light guide plate 400, a second optical sheet 600, a support frame 700, a first optical sheet 800 and a display panel 900, as illustrated in FIGS. 1 and 2.

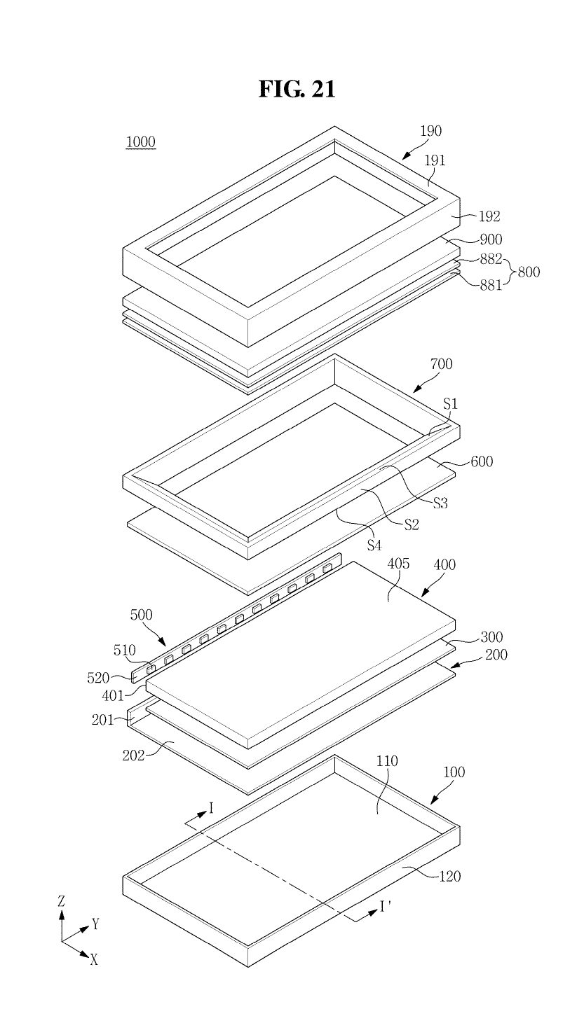

The heat dissipation plate 200, the reflective sheet 300, the light source module 500, the light guide plate 400, the second optical sheet 600, the support frame 700 and the first optical sheet 800 among the aforementioned components are included in this exemplary embodiment of a backlight unit. In an exemplary embodiment, the backlight unit may further include at least one of a bottom case 100 and a top case 190 (see FIG. 21) to be described below.

In an exemplary embodiment, the display panel 900 and the backlight unit are assembled in a laminated state to constitute a display module. The display module may further include the bottom case 100 and the top case, to be described below, for protecting and fastening the display panel 900 and the backlight unit, and a driving circuit board for driving the display panel 900.

The display panel 900 displays an image. The display panel 900 is divided into a display area and a non-display area. The image is displayed in the display area, and signal lines for transmitting image data, various control signals and various power signals to be used for displaying the image are positioned in the non-display area. In addition, a part of or the entirety of driving circuit units that provide the image data, the various control signals and the various power signals may be further provided in the non-display area or at the aforementioned driving circuit board.

Although not illustrated, the display panel 900 according to an exemplary embodiment may be a liquid crystal display (“LCD”) panel including a lower substrate, an upper substrate and a liquid crystal layer between the lower substrate and the upper substrate. Herein, a plurality of gate lines, a plurality of data lines intersecting the plurality of gate lines, pixel electrodes formed in each pixel area, and a thin film transistor (“TFT”) driven by a gate signal applied from the gate line and applying a data signal applied from the data line to the pixel electrode may be positioned at the lower substrate. In addition, a plurality of color filter layers corresponding to the respective pixel areas may be positioned at the upper substrate.

The bottom case 100 may have a space for storage therein, as illustrated in FIG. 1. The heat dissipation plate 200, the reflective sheet 300, the light source module 500, the light guide plate 400, the second optical sheet 600, the support frame 700, the first optical sheet 800 and the display panel 900 are disposed in the space for storage.

For securing such the space for storage, the bottom case 100 may include, for example, a base portion 110 and a side portion 120 in an exemplary embodiment.

The base portion 110 of the bottom case 100 may have a quadrangular plate shape, as in an example shown in FIG. 1.

The side portion 120 of the bottom case 100 may have a shape of a quadrangular ring or a quadrangular closed loop, as an example shown in FIG. 1. The side portion 120 may have a shape protruding from an edge of the base portion 110. In an exemplary embodiment, for example, the side portion 120 may protrude in a direction parallel to a Z-axis (hereinafter, a “Z-axis direction”). The side portion 120 may be at an angle of about 90 degrees with respect to the base portion 110.

As illustrated in FIGS. 1 and 2, the base portion 110 and the side portion 120 may be integrally formed into a monolithic structure. A space defined by the base portion 110 and the side portion 120 becomes the space for storage described above.

The heat dissipation plate 200 discharges the heat generated in a light source 510 of the light source module 500 to the outside of the display device 1000 through the bottom case 100. To this end, at least a portion of the heat dissipation plate 200 may be in direct physical contact with the light source module 500, the base portion 110 of the bottom case 100 and the side portion 120 of the bottom case 100.

The heat dissipation plate 200 may include a first heat dissipation portion 201 and a second heat dissipation portion 202.

As illustrated in FIG. 2, a portion of the first heat dissipation portion 201 may be positioned between the light source module 500 and the side portion 120 of the bottom case 100. The first heat dissipation portion 201 may contact the side portion 120. In an exemplary embodiment, for example, facing surfaces of the first heat dissipation portion 201 and the side surface 120 may directly contact each other.

The second heat dissipation portion 202 extends in a direction parallel to an X axis (hereinafter, “an X-axis direction”) from one edge of the first heat dissipation portion 201. A part of the second heat dissipation portion 202 may be positioned between the base portion 110 of the bottom case 100 and the reflective sheet 300. The second heat dissipation portion 202 may contact the base portion 110. In an exemplary embodiment, for example, facing surfaces of the second heat dissipation portion 202 and the base portion 110 may directly contact each other.

A thickness of the first heat dissipation portion 201 may be greater than a thickness of the second heat dissipation portion 202. The thickness of the first heat dissipation portion 201 refers to the thickness in the X-axis direction and the thickness of the second heat dissipation portion 202 refers to the thickness in the Z-axis direction.

The heat dissipation plate 200 including the first heat dissipation portion 201 and the second heat dissipation portion 202 may have an L-shaped cross-section as illustrated in FIG. 2 at the contact position between the first heat dissipation portion 201 and the second heat dissipation portion 202. In an exemplary embodiment, the heat dissipation plate 200 may include a metal such as an aluminum material.

In another exemplary embodiment, the heat dissipation plate 200 may not be included in the backlight unit.

The light source module 500 provides light. The light source module 500 may be positioned between the side portion 120 of the bottom case 100 and the light guide plate 400. In an exemplary embodiment, for example, the light source module 500 may be positioned between the side portion 120 and a light incidence surface 401 of the light guide plate 400. In an exemplary embodiment, in the case where the heat dissipation plate 200 is included in the backlight unit, as illustrated in FIG. 2, the light source module 500 may be positioned between the heat dissipation plate 200 and the light guide plate 400. In an exemplary embodiment, for example, the light source module 500 may be positioned between the first heat dissipation portion 201 and the light incidence surface 401 of the light guide plate 400.

The light source module 500 may be affixed to the side portion 120 of the bottom case 100 or the first heat dissipation portion 201. In an exemplary embodiment, for example, in the case where the heat dissipation plate 200 is absent, the light source module 500 may be affixed to an inner side surface of the side portion 120. Herein, the inner side surface of the side portion 120 refers to a surface of the side surface 120 that faces the light incidence surface 401 of the light guide plate 400. In an exemplary embodiment, in the case where the heat dissipation plate 200 is present, the light source module 500 may be affixed to an inner side surface of the first heat dissipation plate 201. Herein, the inner side surface of the first heat dissipation portion 201 refers to a surface of the first heat dissipation portion 201 that faces the light incidence surface 401 of the light guide plate 400.

The light source module 500 may include a printed circuit board 520 and at least one light source 510, as illustrated in FIGS. 1 and 2.

One surface of the printed circuit board 520 includes at least one mounting area and a wiring area, although not illustrated. In the case where two or more light sources 510 are provided, one light source 510 is installed in each mounting area and a plurality of signal transmission lines for transmitting a driving power to the light sources 510 are installed in the wiring area. The above-described driving power is generated from an external power supply (not illustrated) and then applied to the plurality of signal transmission lines through a separate connector (not illustrated). The printed circuit board 520 may include a metal material such that a heat generated in the light source 510 may be well transmitted to the heat dissipation plate 200 though the printed circuit board 520.

The light source 510 is driven by the driving power and emits light to the outside. The light source 510 faces the light incidence surface 401 of the light guide plate 400. In an exemplary embodiment, for example, the light source 510 emits light through a light emitting portion of the light source 510 and the light emitting portion of the light source 510 faces the light incidence surface 401 of the light guide plate 400.

The light source 510 may be installed at the printed circuit board 520. Although not illustrated, the light source 510 may include a light emitting diode (“LED”) chip for emitting light and a fluorescent material (e.g., a phosphor) surrounding the LED chip. The LED chip may be a LED chip emitting blue light. The blue light generated from the LED chip is converted into white light while passing through the phosphor.

The reflective sheet 300 may be positioned between the base portion 110 of the bottom case 100 and the light guide plate 400. In an exemplary embodiment, in the case where the heat dissipation plate 200 is included in the backlight unit, as illustrated in FIG. 2, the reflective sheet 300 may be positioned between the heat dissipation plate 200 and the light guide plate 400. For example, the reflective sheet 300 may be positioned between the second heat dissipation portion 202 and the light guide plate 400. In an exemplary embodiment, the reflective sheet 300 may have a white color.

The reflective sheet 300 reflects the light that has passed through a lower surface of the light guide plate 400 and is to be emitted outwards so that the light may propagate back toward the light guide plate 400, thereby substantially minimizing the light loss rate.

In an exemplary embodiment, the reflective sheet 300 may include, for example, polyethylene terephthalate (“PET”), thus having reflectivity. In addition, one surface of the reflective sheet 300 may be coated with a diffusion layer including titanium dioxide. Herein, the surface of the reflective sheet 300 refers to a surface of the reflective sheet 300 that faces the light guide plate 400. In an exemplary embodiment, the reflective sheet 300 may include a metal such as silver (Ag), for example.

The light guide plate 400 may be positioned between the base portion 110 of the bottom case 100 and the support frame 700. In an exemplary embodiment, for example, the light guide plate 400 may be positioned between the reflective sheet 300 and the second optical sheet 600.

The light guide plate 400 guides the light provided from the light source 510 to the display panel 900. In such an exemplary embodiment, the light guide plate 400 may supply the light received from the light source 510 to an entire surface of the display area of the display panel 900 uniformly.

The light guide plate 400 may have a polyhedral shape. Among a plurality of surfaces included in the light guide plate 400, a surface that faces the light source 510 is defined as the light incidence surface 401 and a surface that faces toward the display panel 900 is defined as a light emission surface 405.

The light emitted from the light sources 510 is incident to the light incidence surface 401 of the light guide plate 400. In addition, the light incident to the light incidence surface 401 proceeds to the inside of the light guide plate 400. The light guide plate 400 totally reflects the light that has entered the light guide plate 400 and guides the light outwards through the light emission surface 405. The light directed outwards through the light emission surface 405 passes through the second optical sheet 600 and the first optical sheet 800 and is provided toward the display area of the display panel 900.

In an exemplary embodiment, although not illustrated, the light guide plate 400 may further include a plurality of scattering patterns positioned on the lower surface of the light guide plate 400. In such an exemplary embodiment, as further away from the light incidence surface 401 of the light guide plate 400, an interval between the scattering patterns becomes more and more wider. Herein, the lower surface of the light guide plate 400 refers to a surface of the light guide plate 400, which faces the reflective sheet 300. By virtue of the scattering pattern, the reflectance of the light guide plate 400 may be improved.

In an exemplary embodiment, the light guide plate 400 may include a light transmitting material, for example, an acrylic resin, such as polymethylmethacrylate (“PMMA”), or polycarbonate (“PC”).

The second optical sheet 600 may be positioned between the light guide plate 400 and the support frame 700. In an exemplary embodiment, for example, the second optical sheet 600 may be positioned between the light emission surface 405 of the light guide plate 400 and the support frame 700. The second optical sheet 600 diffuses or collimates the light transmitted through the light emission surface 405 of the light guide plate 400.

In an exemplary embodiment, as illustrated in FIG. 2, the second optical sheet 600 may have a longer length than a length of the light emission surface 405 of the light guide plate 400. Herein, the length of the second optical sheet 600 and the length of the light guide plate 400 refer to the length in the X-axis direction.

In the case where the length of the second optical sheet 600 is longer than the length of the light emission surface 405 of the light guide plate 400, a portion of the second optical sheet 600 does not overlap the light guide plate 400 in the Z-axis direction, and the portion of the second optical sheet 600 is to be defined as an extension portion of the second optical sheet 600. The extension portion of the second optical sheet 600 may be positioned between the support frame 700 and the second heat dissipation portion 202. In such an exemplary embodiment, the extension portion of the second optical sheet 600 overlaps with at least a portion of the light source 510. In other words, the light source 510 may be positioned between the extension portion of the second optical sheet 600 and the second heat dissipation portion 202 or the base portion 110.

In another exemplary embodiment, the second optical sheet 600 may not be included in the backlight unit.

The support frame 700 may be positioned between the base portion 110 of the bottom case 100 and the display panel 900. In an exemplary embodiment, for example, as illustrated in FIG. 2, the support frame 700 may be positioned between the second optical sheet 600 and the first optical sheet 800. As illustrated in FIG. 2, the support frame 700 overlaps the light source module 500, an edge of the light guide plate 400 and an edge of the second optical sheet 600 in the Z-axis direction.

The support frame 700 may have the shape of a quadrangular ring or a quadrangular closed loop, as illustrated in FIG. 1. An inner side surface S1 of the support frame 700 may have an inclination other than 90 degrees. In an exemplary embodiment, for example, an angle θ1 between the inner side surface S1 of the support frame 700 and the first optical sheet 800 may be an acute angle. In an exemplary embodiment, for example, the angle θ1 between the first optical sheet 800 and the inner side surface S1 of the support frame 700 may be in a range from about 60 degrees to about 80 degrees. As a more specific example, the angle θ1 may be in a range from about 65 degrees to about 70 degrees. Herein, if, among surfaces included the support frame 700, a surface that faces the side portion 120 is defined as an outer side surface S2 of the support frame 700, the inner side surface S1 of the support frame 700 described above refers to a surface on the opposite side of the outer side surface S2 of the support frame 700.

An upper surface S3 of the support frame 700 faces an edge of the first optical sheet 800. The upper surface S3 of the support frame 700 may directly contact the first optical sheet 800.

A lower surface S4 of the support frame 700 faces an edge of the second optical sheet 600 and the first heat dissipation portion 201. Herein, the lower surface S4 of the support frame 700 refers to a surface on the opposite side of the upper surface S3 of the support frame 700. The lower surface S4 of the support frame 700 may directly contact the second optical sheet 600 and the first heat dissipation portion 201

A cross-section of the support frame 700 may have a trapezoidal shape having one hypotenuse, as illustrated in FIG. 2. Herein, the hypotenuse corresponds to the inner side surface S1 of the support frame 700. In other words, the hypotenuse is a part of the inner side surface S1 of the support frame 700. Accordingly, an angle between the hypotenuse and the first optical sheet 800 is substantially the same as the angle θ1 between the inner side surface S1 of the support frame 700 and the first optical sheet 800. In addition, the angle between the hypotenuse and the first optical sheet 800 is substantially the same as an angle θ2 between the inner side surface S1 of the support frame 700 and the lower surface S4, since the hypotenuse is a part of the inner side surface S1.

The support frame 700 may have a white surface. In an exemplary embodiment, for example, at least one of the outer side surface S2, the inner side surface S1, the upper surface S3 and the lower surface S4 of the support frame 700 may have a white color. As an example, the inner side surface S1 of the support frame 700 may have a white color. As another example, a white reflective tape may be affixed to at least one of the outer side surface S2, the inner side surface S1, the upper surface S3 and the lower surface S4 of the support frame 700. As a specific example, a white reflective tape may be affixed to the inner side surface S1 of the support frame 700.

The first optical sheet 800 may be positioned between the support frame 700 and the display panel 900. An edge of the first optical sheet 800 is positioned on the upper surface S3 of the support frame 700.

The first optical sheet 800 may be affixed to the display panel 900. To this end, an adhesive may be positioned between the first optical sheet 800 and the display panel 900.

The first optical sheet 800 diffuses and collimates the light transmitted through the light guide plate 400 or the second optical sheet 600. The first optical sheet 800 may include a plurality of sheets positioned at different distances from the display panel 900. In an exemplary embodiment, for example, the first optical sheet 800 may include a diffusion sheet 881 and a light collimation sheet 882.

The diffusion sheet 881 and the light collimation sheet 882 are sequentially stacked on the support frame 700 in the order listed. That is, among the diffusion sheet 881 and the light collimation sheet 882, the light collimation sheet 882 is positioned closer to the display panel 900.

In an exemplary embodiment, although not illustrated, the first optical sheet 800 may further include a protective sheet. This protective sheet may be positioned between the light collimation sheet 882 and the display panel 900. In another exemplary embodiment, the positions of the diffusion sheet 881 and the light collimation sheet 882 may be reversed. That is, the diffusion sheet 881 may be positioned between the light collimation sheet 882 and the display panel 900. In an exemplary embodiment, as another example, the second optical sheet 600 may include two diffusion sheets. In such an exemplary embodiment, the two diffusion sheets may have different haze values. In an exemplary embodiment, for example, one of the two diffusion sheets 881, that is closer to the display panel 900, may have a less haze value than a haze value of the other of the two diffusion sheets 881.

The diffusion sheet 881 disperses the light transmitted from the light guide plate 400 or the second optical sheet 600 to substantially prevent the light from being partially concentrated.

The light collimation sheet 882 is positioned on the diffusion sheet 881 and serves to collimate the light diffused from the diffusion sheet 881 in a direction perpendicular to the display panel 900. For this purpose, prisms having a triangular cross-section may be arranged on a surface of the light collimation sheet 882 in a predetermined arrangement.

The protective sheet is positioned on the light collimation sheet 882 to protect a surface of the light collimation sheet 882 and to diffuse the light received from the light collimation sheet 882 to make the light distributed uniformly. A light that has passed through the protective sheet is provided to the display panel 900.

Each of the display panel 900, the first optical sheet 800, the support frame 700 and the heat dissipation plate 200 may directly contact the side portions 120. In addition, the heat dissipation plate 200 may directly contact the base portion 110.

In an exemplary embodiment, the display panel 900 and the side portions 120 may be attached to each other by an adhesive member positioned therebetween. In addition, the support frame 700 and the side portions 120 may be attached to each other by an adhesive member positioned therebetween. In addition, the heat dissipation plate 200 and the side portions 120 may be attached to each other by an adhesive member positioned therebetween. In addition, the heat dissipation plate 200 and the base portion 110 may be attached to each other by an adhesive member positioned therebetween. In an exemplary embodiment, the aforementioned adhesive member may be silicon, for example.

As described above, the backlight unit according to an exemplary embodiment includes the light guide plate 400 and thus may have a shorter optical distance than that of the conventional direct-type backlight unit. Accordingly, the display device 1000 including the backlight unit according to an exemplary embodiment may have a less thickness T than a thickness of the conventional display device including the conventional direct-type backlight unit.

In addition, the backlight unit according to an exemplary embodiment includes the support frame 700 and thus may have a bezel area having a less width W than that of the conventional edge-type backlight unit. Herein, the bezel area refers to an area including a width of the side portion 120 and the non-display area of the display panel 900.

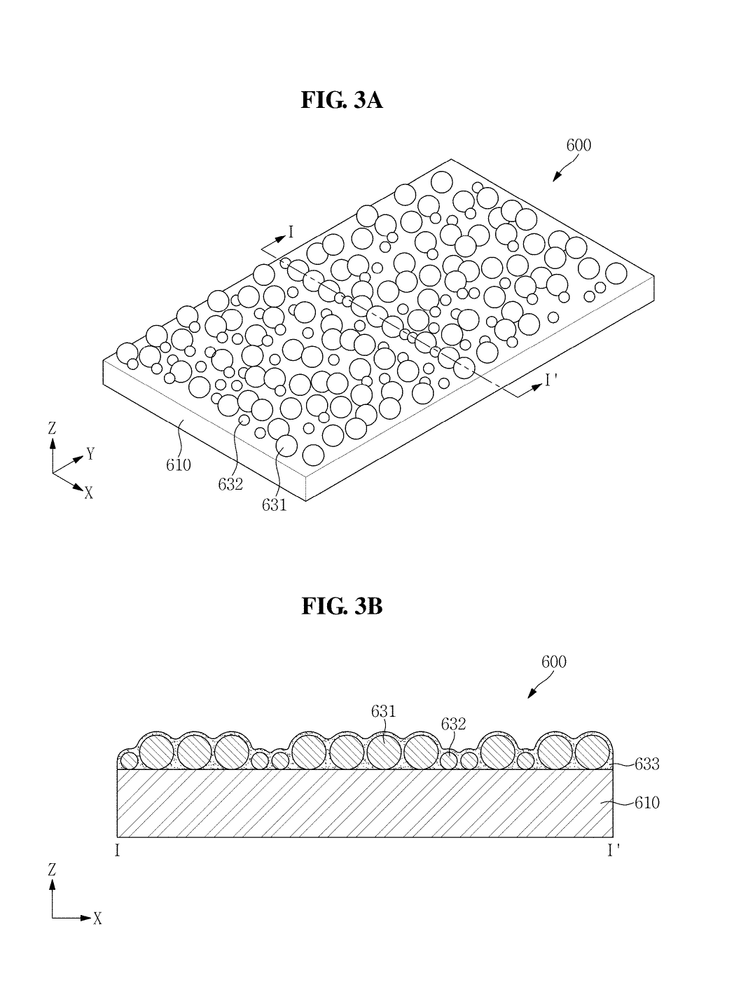

FIG. 3A is a prospective view illustrating an exemplary embodiment of the second optical sheet 600 of FIG. 1, and FIG. 3B is a cross-sectional view taken along line I-I′ of FIG. 3A.

The second optical sheet 600 may include a film 610, a plurality of diffusers 631 and 632 and an adhesive 633, as illustrated in FIGS. 3A and 3B. The plurality of diffusers 631 and 632 are positioned on the film 610. These diffusers 631 and 632 face the first optical sheet 800.

The adhesive 633 is positioned between the diffusers 631 and 632 and between the film 610 and the diffusers 631 and 632. In addition, the adhesive 633 is positioned on the diffusers 631 and 632. The adhesive 633 attaches the film 610 and the diffusers 631 and 632 to each other.

Each of the plurality of diffusers 631 and 632 may have the shape of a sphere. The plurality of diffusers 631 and 632 may have different refractive indices from each other.

The plurality of diffusers 631 and 632 may include a first diffuser 631 having a relatively large diameter and a second diffuser 632 having a less diameter than that of the first diffuser 631.

The first diffuser 631 may have a refractive index different from that of the second diffuser 632. In an exemplary embodiment, for example, the first diffuser 631 may have a greater refractive index than that of the second diffuser 632.

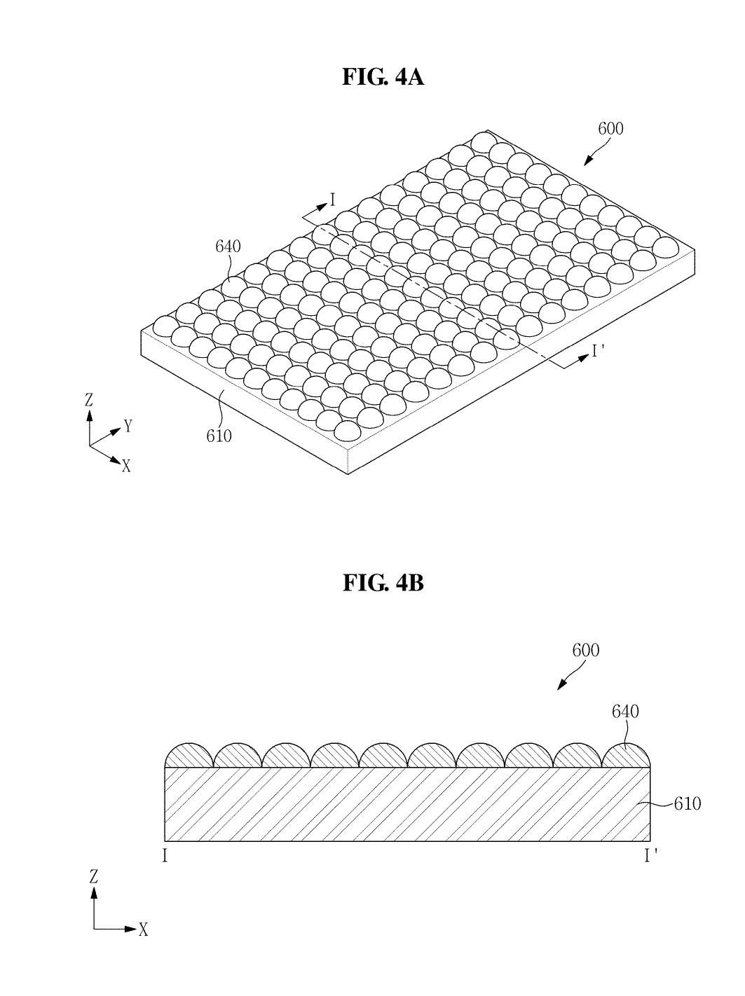

FIG. 4A is a perspective view illustrating another exemplary embodiment of the second optical sheet 600 of FIG. 1, and FIG. 4B is a cross-sectional view taken along line I-I′ of FIG. 4A.

The second optical sheet 600 may include a film 610 and a plurality of convex lens patterns 640, as illustrated in FIGS. 4A and 4B. The plurality of convex lens patterns 640 are positioned on the film 610. The convex lens patterns 640 face a first optical sheet 800.

Each of the plurality of convex lens patterns 640 may have a hemispherical shape. A convex surface of each convex lens pattern faces the first optical sheet 800.

Adjacent ones of the convex lens patterns 640 may contact each other. Although not illustrated, in an alternative exemplary embodiment, the adjacent ones of the convex lens patterns 640 may be spaced apart from each other by a predetermined distance, not contacting each other.

Each of the plurality of convex lens patterns 640 may have a substantially same size and a substantially same shape. In an exemplary embodiment, for example, each of the convex lens patterns 640 may have a substantially same diameter and a substantially same curvature. In another alternative exemplary embodiment, at least two convex lens patterns 640 may have different diameters and different curvatures from each other.

The plurality of convex lens patterns 640 may be arranged in a matrix on the film 610, as illustrated in FIG. 4A.

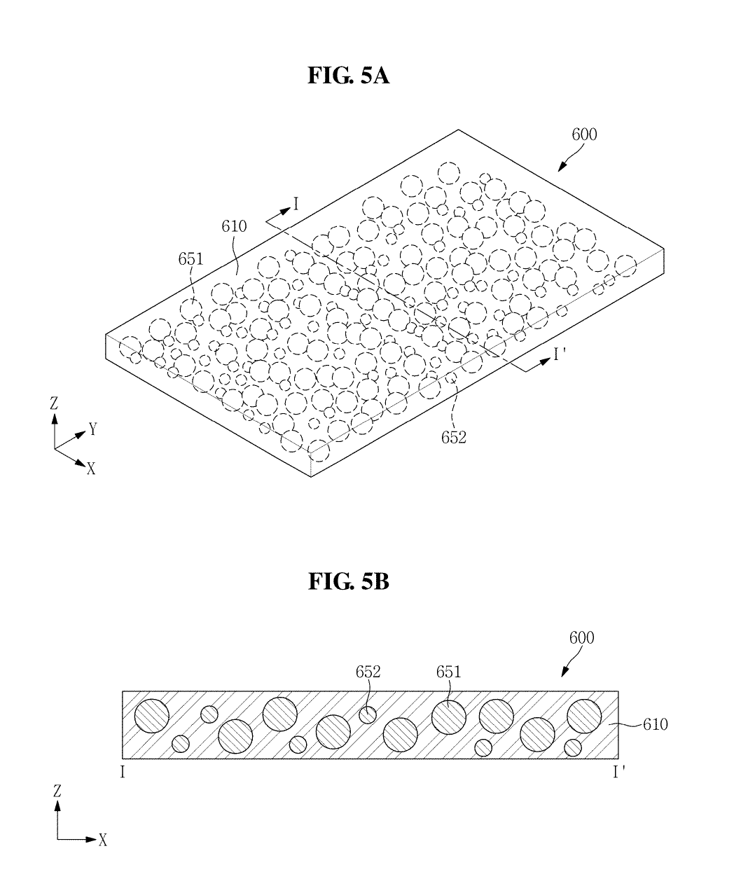

FIG. 5A is a prospective view illustrating still another exemplary embodiment of the second optical sheet of FIG. 1, and FIG. 5B is a cross-sectional view taken along line I-I′ of FIG. 5A.

The second optical sheet 600 may include a film 610 and a plurality of diffusers 651 and 652, as illustrated in FIGS. 5A and 5B. The plurality of diffusers 651 and 652 are positioned in the film 610.

Each of the plurality of diffusers 651 and 652 may have the shape of a sphere. The plurality of diffusers 651 and 652 may have different refractive indices.

The plurality of diffusers 651 and 652 may include a first diffuser 651 having a relatively large diameter and a second diffuser 652 having a less diameter than that of the first diffuser 651. The first diffuser 651 may have a different refractive index from that of the second diffuser 652. In an exemplary embodiment, for example, the first diffuser 651 may have a greater refractive index than that of the second diffuser 652.

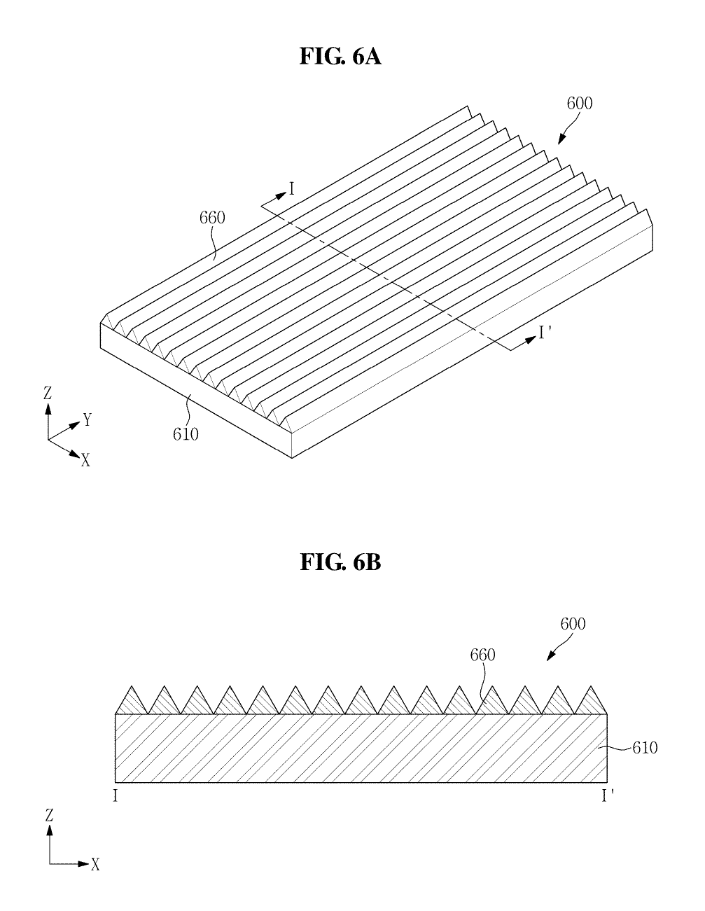

FIG. 6A is a prospective view illustrating still another exemplary embodiment of the second optical sheet of FIG. 1, and FIG. 6B is a cross-sectional view taken along line I-I′ of FIG. 6A.

The second optical sheet 600 may include a film 610 and a plurality of prism lens patterns 660, as illustrated in FIGS. 6A and 6B. The plurality of prism lens patterns 660 are positioned on the film 610. The prism lens patterns 660 face a first optical sheet 800.

Each prism lens pattern 660 may have the shape of a triangular prism. A pointed portion of each prism lens pattern 660 faces the first optical sheet 800

Adjacent ones of the prism lens patterns 660 may contact each other. Although not illustrated, in an alternative exemplary embodiment, the adjacent ones of the prism lens patterns 660 may be spaced apart from each other by a predetermined distance, not contacting each other.

Each of the prism lens patterns 660 may have a substantially same size and a substantially same shape. In another alternative exemplary embodiment, at least two prism lens patterns 660 may have different sizes and different shapes from each other.

The plurality of prism lens patterns 660 may be arranged in a stripe form on the film 610, as illustrated in FIG. 6A.

In an exemplary embodiment, although not illustrated, a height of an odd-numbered prism lens pattern and a height of an even-numbered prism lens pattern may be different from each other. In an exemplary embodiment, for example, the height of the odd-numbered prism lens pattern may be greater than the height of the even-numbered prism lens pattern. Herein, the height of the prism lens pattern refers to a distance from a reference surface of the film 610 to a top edge of the prism lens pattern. That is, this height refers to a distance measured in the Z-axis direction from the reference surface of the film 610. In addition, the reference surface of the film 610 refers to one of surfaces of the film 610 that contacts the prism lens pattern 660. The top edge of the prism lens pattern 660 refers to one of edges of the prism lens pattern that is not in contact with the reference surface.

Although not illustrated, at least one film 610 of the second optical sheets 600 of FIGS. 3A, 4A, 5A and 6A may include a quantum dot or a quantum rod therein.

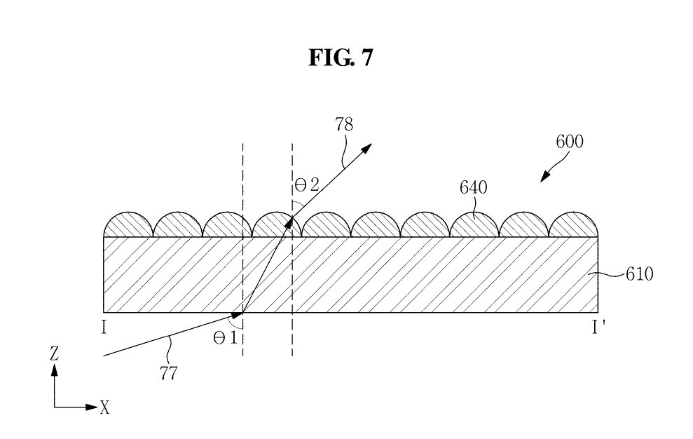

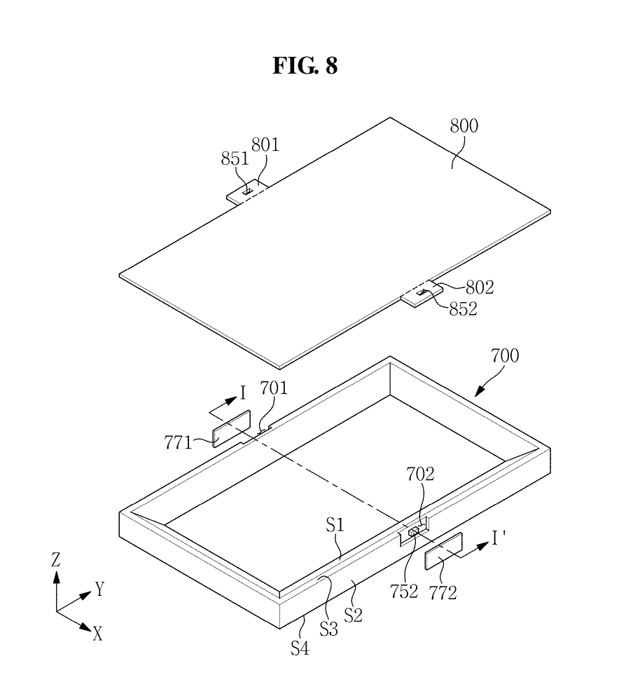

FIG. 7 is an explanatory view illustrating an exemplary embodiment of an optical path of a light passing through the second optical sheet 600 of FIG. 4A.

As illustrated in FIG. 7, a light 77 received from the light guide plate 400 passes through the film 610 and the convex lens pattern 640. In such an exemplary embodiment, an emission angle φ2 of a light 78 that has passed through the convex lens pattern 640 to be emitted outwards is less than an incidence angle φ1 of the light 77 that is incident to the film 610 from the light guide plate 400. Most of the light 78 of FIG. 7, which has emitted from the convex lens pattern 640 as a result of passing through the second optical sheet 600, is emitted at the aforementioned emission angle φ2.

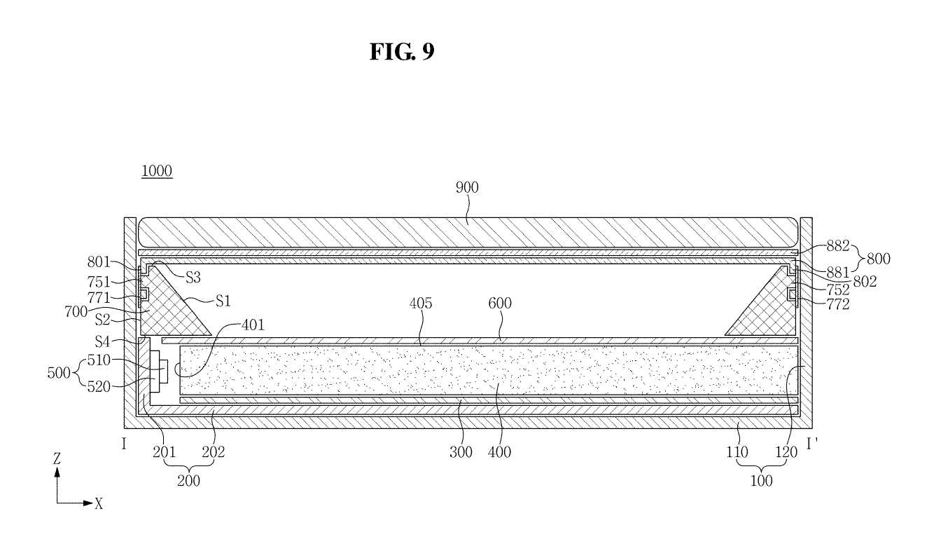

FIG. 8 is an explanatory view illustrating an exemplary embodiment of the coupling relationship between the first optical sheet 800 and the support frame 700 of FIG. 1, and FIG. 9 is a cross-sectional view taken along line I-I′ of FIG. 8. The bottom case 100, the reflective sheet 300, the light source module 500, the heat dissipation plate 200 and the light guide plate 400, the second optical sheet 600 and the display panel 900 are further illustrated in FIG. 9, in addition to the first optical sheet 800 and the support frame 700 of FIG. 8.

The first optical sheet 800 may further include at least one fastening portion 801. In an exemplary embodiment, for example, as illustrated in FIG. 8, the first optical sheet 800 may include a first fastening portion 801 and a second fastening portion 802.

The first fastening portion 801 and the second fastening portion 802 have first and second fastening holes 851 and 852, respectively. The first fastening portion 801 may protrude in the X-axis direction from one (hereinafter, “a first side”) of two opposite sides of the first optical sheet 800, and the second fastening portion 802 may protrude in the X-axis direction from the other (hereinafter, “a second side”) of the two opposite sides of the first optical sheet 800. In such an exemplary embodiment, the first fastening portion 801 may be positioned at a central portion of the first side and the second fastening portion 802 may be positioned at a central portion of the second side. Although not illustrated, the first optical sheet 800 may further include at least one more fastening portion (hereinafter, “an auxiliary fastening portion”) protruding from at least one of the other sides other than the first side and the second side.

The support frame 700 has at least one fastening groove. In an exemplary embodiment, for example, as illustrated in FIG. 8, a first fastening groove 701 and a second fastening groove 702 are positioned at different portions of the outer side surface S2 of the support frame 700. As a more specific example, the first fastening groove 701 is positioned at one of two opposite portions of the outer side surface S2 of the support frame 700, and the second fastening groove 702 is positioned at the other of the two opposite portions of the outer side surface S2 of the support frame 700. Although not illustrated, the support frame 700 may further include a fastening groove (hereinafter, “an auxiliary fastening groove”) positioned at a portion of the outer side surface S2 corresponding to the auxiliary fastening portion.

In addition, the support frame 700 may further include at least one fastening projection. In an exemplary embodiment, for example, as illustrated in FIGS. 8 and 9, the support frame 700 may include a first fastening projection 751 and a second fastening projection 752. The first fastening projection 751 is positioned at the first fastening groove 701 and the second fastening projection 752 is positioned at the second fastening groove 702. Although not illustrated, the support frame 700 may further include an auxiliary fastening projection positioned at the auxiliary fastening groove.

The first fastening portion 801 is folded so as to face the first fastening groove 701, as illustrated in FIG. 9 when assembled. The first fastening portion 801 in the folded state may have an angle of about 90 degrees with respect to the first optical sheet 800. The second fastening portion 802 is folded so as to face the second fastening groove 702, as illustrated in FIG. 9. The second fastening portion 802 in the folded state may have an angle of about 90 degrees with respect to the first optical sheet 800.

The first fastening portion 801 in the folded state is inserted to the first fastening groove 701. In such an exemplary embodiment, the first fastening projection 751 in the first fastening groove 701 is inserted to the first fastening hole 851 of the first fastening portion 801. The second fastening portion 802 in the folded state is inserted to the second fastening groove 702. In such an exemplary embodiment, the second fastening projection 752 in the second fastening groove 702 is inserted to the second fastening hole 852 of the first fastening portion 801.

In the state that the first fastening portion 801 is inserted to the first fastening groove 701, as illustrated in FIG. 9, a first tape 771 may be further affixed to a portion of the outer side surface S2 of the support frame 700 which surrounds the first fastening groove 701 to cover the first fastening portion 801, the first fastening projection 751 and the first fastening groove 701. The first tape 771 has an area which is larger than an area of the first fastening portion 801 or the first fastening groove 701.

In the state that the second fastening portion 802 is inserted to the second fastening groove 702, as illustrated in FIG. 9, a second tape 772 may be further affixed to a portion of the outer side surface S2 of the support frame 700 which surrounds the second fastening groove 702 to cover the second fastening portion 802, the second fastening projection 752 and the second fastening groove 702. The second tape 772 has an area which is larger than an area of the second fastening portion 802 or the second fastening groove 702.

As illustrated in FIG. 9, the first fastening portion 801 of the first optical sheet 800 is positioned between the first tape 771 and the supporting frame 700, and the second fastening portion 802 of the first optical sheet 800 is positioned between the second tape 772 and the support frame 700.

The first optical sheet 800 of FIG. 8 may be one of the diffusion sheet 881, the light collimation sheet 882 and the protective sheet described above.

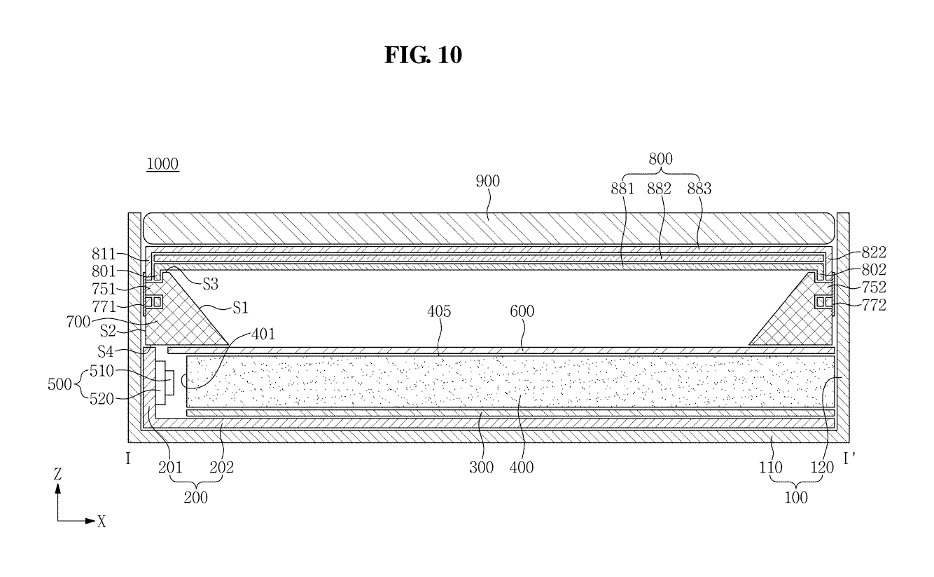

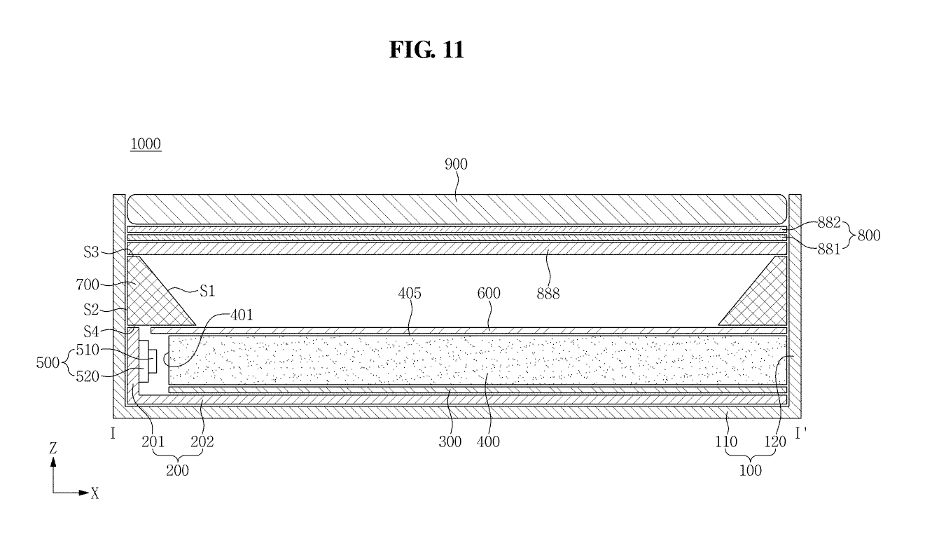

In the case where the first optical sheet 800 includes a plurality of sheets, a sheet among the plurality of sheets, that is positioned closer to the display panel 900 or the support frame 700, may include at least one fastening portion described above, which will be described in detail with reference to FIG. 10.

FIG. 10 is an explanatory view illustrating an exemplary embodiment of the coupling relationship between the support frame 700 and an optical sheet 881, a light collimation sheet 882 and a protective sheet 883, when the optical sheet 881, the light collimation sheet 882 and the protective sheet 883 are included in the first optical sheet 800.

As illustrated in FIG. 10, the diffusion sheet 881, which is a lowermost sheet of the diffusion sheet 881, the light collimation sheet 882 and the protective sheet 883, is positioned closest to the support frame 700 among the diffusion sheet 881, the light collimation sheet 882 and the protective sheet 883. In addition, the protective sheet 883, which is an uppermost sheet of the diffusion sheet 881, the light collimation sheet 882 and the protective sheet 883, is positioned closest to the display panel 900 among the diffusion sheet 881, the light collimation sheet 882 and the protective sheet 883.

The diffusion sheet 881 and the protective sheet 883 may include at least one fastening portion described above, respectively. However, the light collimation sheet 882 between the diffusion sheet 881 and the protective sheet 883 may not include a fastening portion.

In an exemplary embodiment, for example, the first fastening portion 801 of the diffusion sheet 881 and a first fastening portion 811 of the protective sheet 883 are inserted to the first fastening groove 701 (see FIG. 8) of the support frame 700. In such an exemplary embodiment, the first fastening portion 801 of the diffusion sheet 881 is firstly inserted to the first fastening groove 701 and then the first fastening portion 811 of the protective sheet 883 is inserted to the first fastening groove 701. The first fastening projection 751 is inserted to the first fastening hole 851 (see FIG. 8) of the first fastening portion 801 provided at the diffusion sheet 881 and to a fastening hole of the first fastening portion 811 provided at the protective sheet 883.

The second fastening portion 802 of the diffusion sheet 881 and a second fastening portion 822 of the protective sheet 883 are inserted to the second fastening groove 702 (see FIG. 8) of the support frame 700. In such an exemplary embodiment, the second fastening portion 802 of the diffusion sheet 881 is firstly inserted to the second fastening groove 702 and then the second fastening portion 822 of the protective sheet 883 is inserted to the second fastening groove 702. The second fastening projection 752 is inserted to the second fastening hole 852 (see FIG. 8) of the second fastening portion 802 provided at the diffusion sheet 881 and to a fastening hole of the second fastening portion 822 provided at the protective sheet 883.

As illustrated in FIG. 10, the first fastening portion 801 of the diffusion sheet 881 is positioned between the first fastening portion 811 of the protective sheet 883 and the support frame 700, and the second fastening portion 802 of the diffusion sheet 881 is positioned between the second fastening portion 822 of the protective sheet 883 and the support frame 700. In addition, the first fastening portion 811 of the protective sheet 883 is positioned between the first fastening portion 801 of the diffusion sheet 881 and the first tape 771, and the second fastening portion 822 of the protective sheet 883 is positioned between the second fastening portion 802 of the diffusion sheet 881 and the second tape 772.

FIG. 11 is a cross-sectional view of another exemplary embodiment taken along line I-I′ of FIG. 1.

As illustrated in FIG. 11, a diffusion plate 888 may be further positioned between the support frame 700 and the first optical sheet 800. The first optical sheet 800 may be supported by the diffusion plate 888. The diffusion plate 888 may have a greater thickness than a thickness of any one of the sheets included in the first optical sheet 800. Herein, the thickness of the diffusion plate 888 and that of the sheets refer to the thickness in the Z-axis direction.

The diffusion plate 888 may have a substantially same shape and a substantially same area as those of any one of the sheets included in the first optical sheet 800.

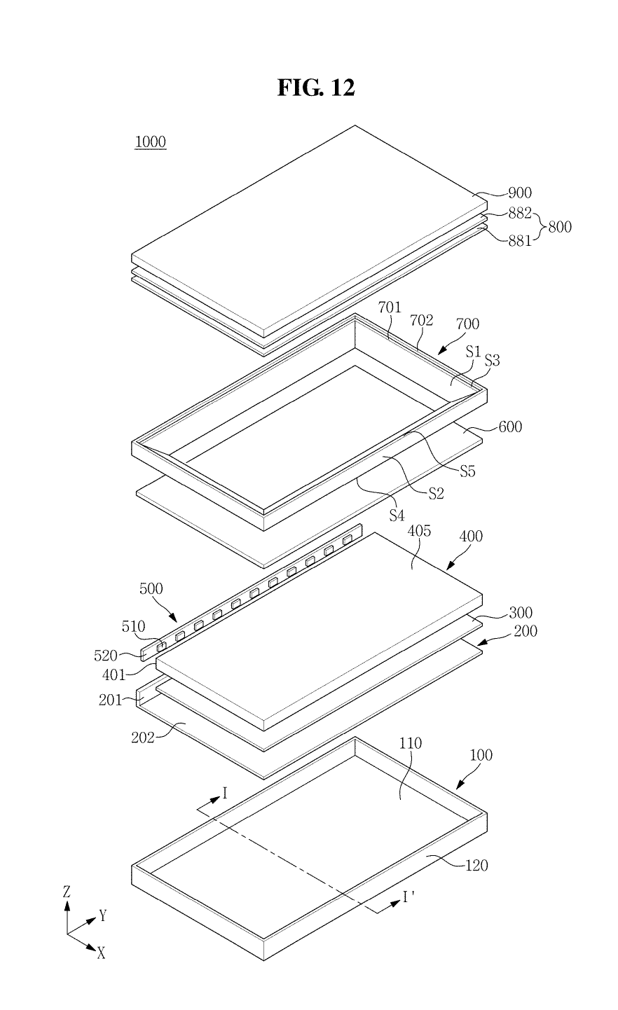

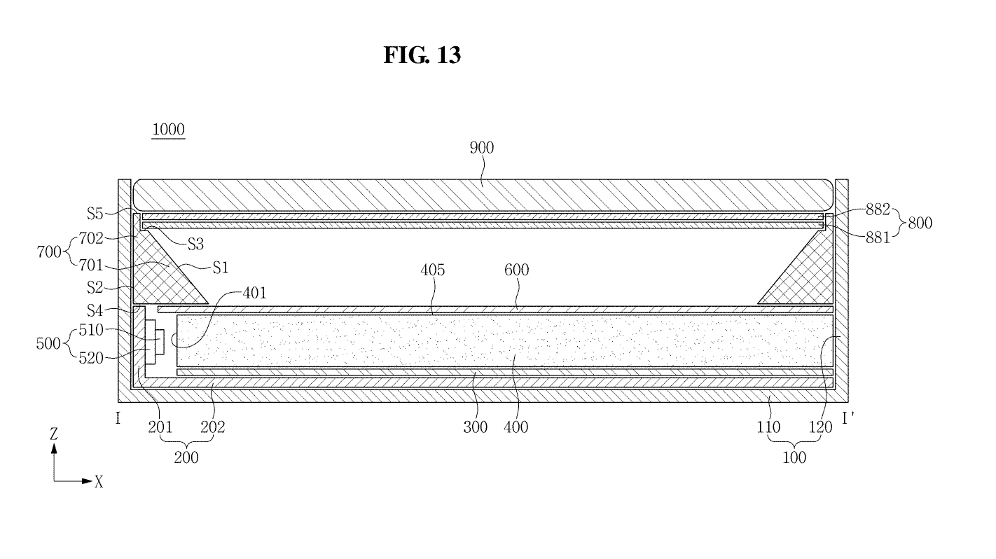

FIG. 12 is an exploded perspective view illustrating another exemplary embodiment of a display device 1000 including a backlight unit according to the invention, and FIG. 13 is a cross-sectional view taken along line I-I′ of FIG. 12.

As illustrated in FIG. 13, a support frame 700 may have a cross-section of a step shape. In an exemplary embodiment, for example, the support frame 700 may include an inner frame 701 and an outer frame 702 having different heights from each other.

As illustrated in FIG. 12, each of the inner frame 701 and the outer frame 702 may have the shape of a quadrangular ring or a quadrangular closed loop. The outer frame 702 encloses the inner frame 701. The outer frame 702 has a greater height than a height of the inner frame 701. Herein, the respective heights of the inner frame 701 and the outer frame 702 refer to the height in the Z-axis direction. In an exemplary embodiment, for example, a maximum height of the outer frame 702 measured in the Z-axis direction with respect to a base portion 110 is higher than a maximum height of the inner frame 701 measured in the Z-axis direction with respect to the base portion 110. In an exemplary embodiment, the inner frame 701 and the outer frame 702 may be formed integrally into a monolithic structure.

An upper surface S3 of the inner frame 701 may face an edge of a first optical sheet 800 and an upper surface S5 of the outer frame 702 may face an edge of a display panel 900. The inner frame 701 may support the first optical sheet 800 and the outer frame 702 may support the display panel 900.

The inner frame 701 is substantially the same as the support frame 700 of FIG. 1 described above.

A bottom case 100, a heat dissipation plate 200, a reflective sheet 300, a light source module 500, a light guide plate 400, a second optical sheet 600, the first optical sheet 800 and the display panel 900 of FIG. 12 are substantially the same as the bottom case 100, the heat dissipation plate 200, the reflective sheet 300, the light source module 500, the light guide plate 400, the second optical sheet 600, the first optical sheet 800 and the display panel 900 of FIG. 1, respectively, and thus detailed descriptions thereof will make reference to FIG. 1 and the related descriptions thereof.

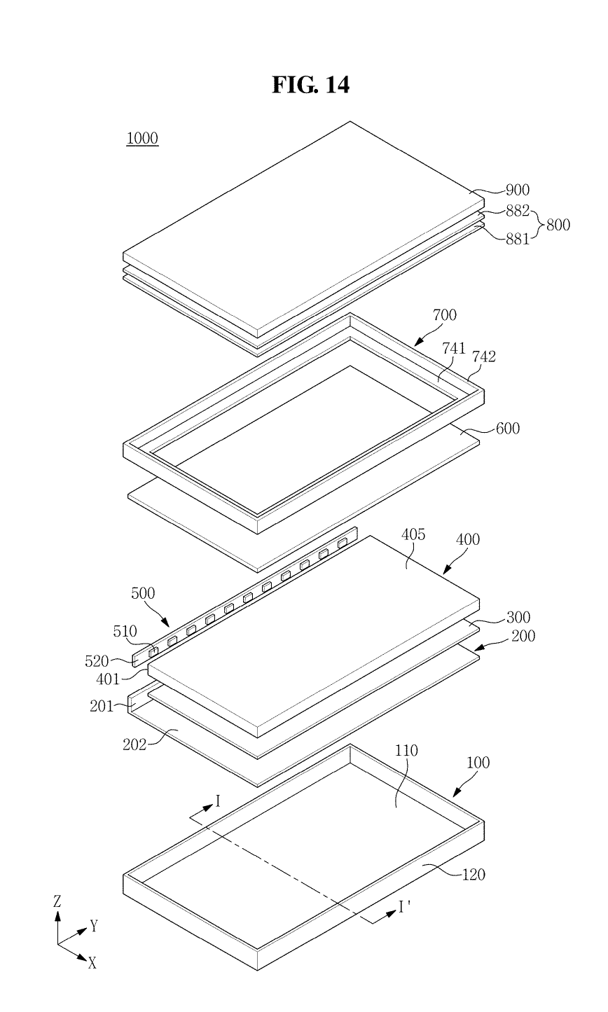

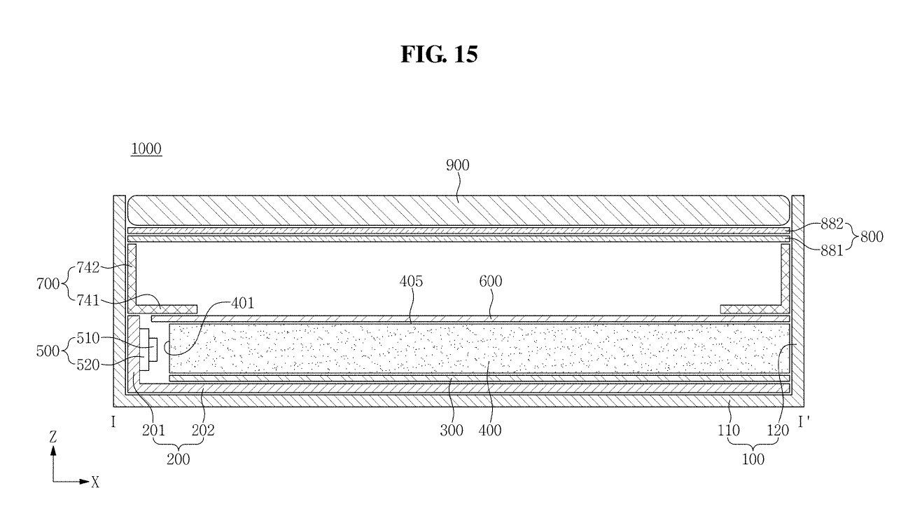

FIG. 14 is a view illustrating another exemplary embodiment of a display device 1000 including a backlight unit, and FIG. 15 is a cross-sectional view illustrating an exemplary embodiment taken along line I-I′ of FIG. 14.

As illustrated in FIGS. 14 and 15, a support frame 700 may include a horizontal portion 741 and a vertical portion 742. In an exemplary embodiment, the horizontal portion 741 and the vertical portion 742 may be integrally formed into a monolithic structure.

The horizontal portion 741 overlaps a light source module 500, an edge of a light guide plate 400 and an edge of a second optical sheet 600. The horizontal portion 741 may directly contact a first heat dissipation portion 201, the second optical sheet 600 and a side portion 120.

The vertical portion 742 protrudes toward a first optical sheet 800 from the horizontal portion 741. In an exemplary embodiment, for example, the vertical portion 742 protrudes in the Z-axis direction from an edge of the horizontal portion 741. Herein, the edge of the horizontal part 741 refers to an edge of the horizontal portion 741 that is close to the side portion 120 among the horizontal portion 741.

The vertical portion 742 and the horizontal portion 741 may have an angle of about 90 degrees therebetween.

The vertical portion 742 faces an edge of the first optical sheet 800. The vertical portion 742 supports the first optical sheet 800.

The support frame 700 including the horizontal portion 741 and the vertical portion 742 may have an L-shaped cross-section, as illustrated in FIG. 15.

As illustrated in FIG. 14, the support frame 700 may have the shape of a quadrangular ring or a quadrangular closed loop.

A bottom case 100, a heat dissipation plate 200, a reflective sheet 300, the light source module 500, the light guide plate 400, the second optical sheet 600, the first optical sheet 800 and the display panel 900 of FIG. 14 are substantially the same as the bottom case 100, the heat dissipation plate 200, the reflective sheet 300, the light source module 500, the light guide plate 400, the second optical sheet 600, the first optical sheet 800 and the display panel 900 of FIG. 1, respectively, and thus detailed descriptions thereof will make reference to FIG. 1 and the related descriptions thereof.

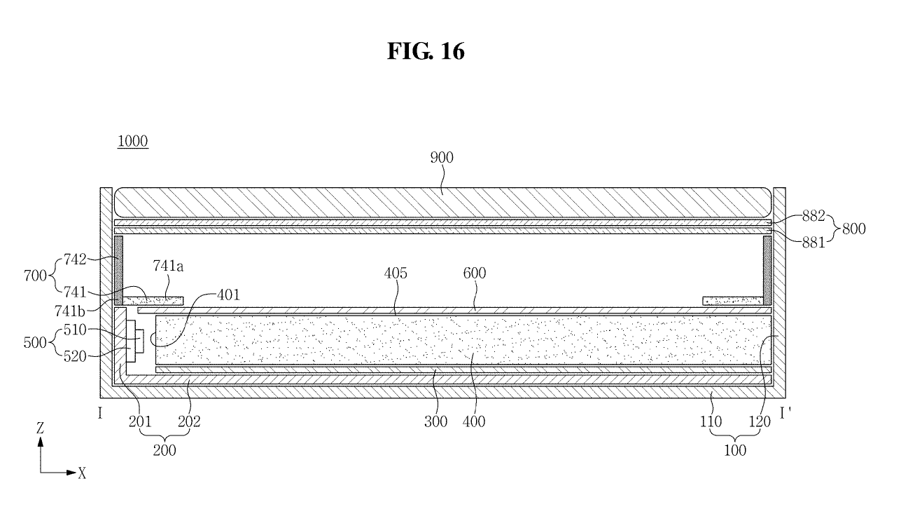

FIG. 16 is a cross-sectional view illustrating another exemplary embodiment taken along line I-I′ of FIG. 14.

As illustrated in FIG. 16, a support frame 700 includes a horizontal portion 741 and a vertical portion 742.

The horizontal portion 741 includes a portion 741b (hereinafter, “an overlap portion)” overlapping the vertical portion 742 and a portion 741a (hereinafter, “a non-overlap portion”) not overlapping the vertical portion 742.

The vertical portion 742 and the overlap portion 741b may have different light transmittances from a light transmittance of the non-overlap portion 741a. In an exemplary embodiment, for example, the non-overlap portion 741a may have a higher light transmittance than a transmittance of the vertical portion 742 and a transmittance of the overlap portion 741b. To this end, in an exemplary embodiment, the non-overlap portion 741a may include a translucent material and each of the vertical portion 742 and the overlap portion 741b may include an opaque material. In such an exemplary embodiment, the non-overlap portion 741a including the translucent material may have a light transmittance in a range from about 30% to about 90%, and each of the vertical portion 742 and the overlap portion 741b may have a light transmittance of substantially 0%.

Each of a surface of the vertical portion 742 and a surface of the overlap portion 741b may have a black color or a white color.

A light from a light source 510 that is incident to a reflective sheet 300 or a heat dissipation plate 200, without being incident to a light guide plate 400, may be reflected from the reflective sheet 300 and the heat dissipation plate 200. In such an exemplary embodiment, the reflected light may be directed toward the non-overlap portion 741a of the horizontal portion 741, and the light may be supplied to the display panel 900 through the non-overlap portion 741a including the translucent material. Accordingly, the luminous efficiency may be improved.

A bottom case 100, the heat dissipation plate 200, the reflective sheet 300, a light source module 500, the light guide plate 400, a second optical sheet 600, a first optical sheet 800 and the display panel 900 of FIG. 16 are substantially the same as the bottom case 100, the heat dissipation plate 200, the reflective sheet 300, the light source module 500, the light guide plate 400, the second optical sheet 600, the first optical sheet 800 and the display panel 900 of FIG. 1, respectively, and thus detailed descriptions thereof will make reference to FIG. 1 and the related descriptions thereof.

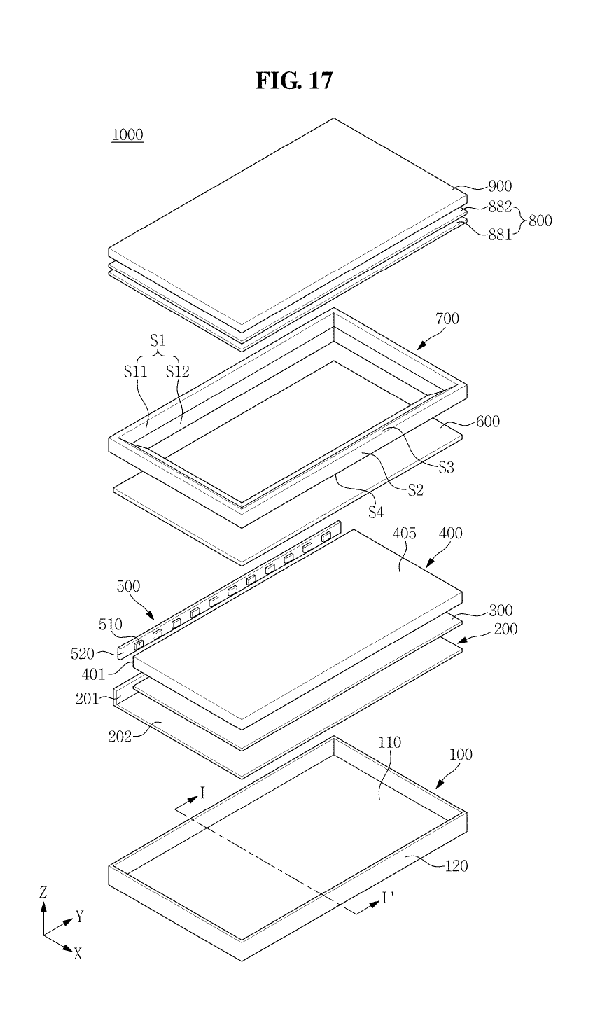

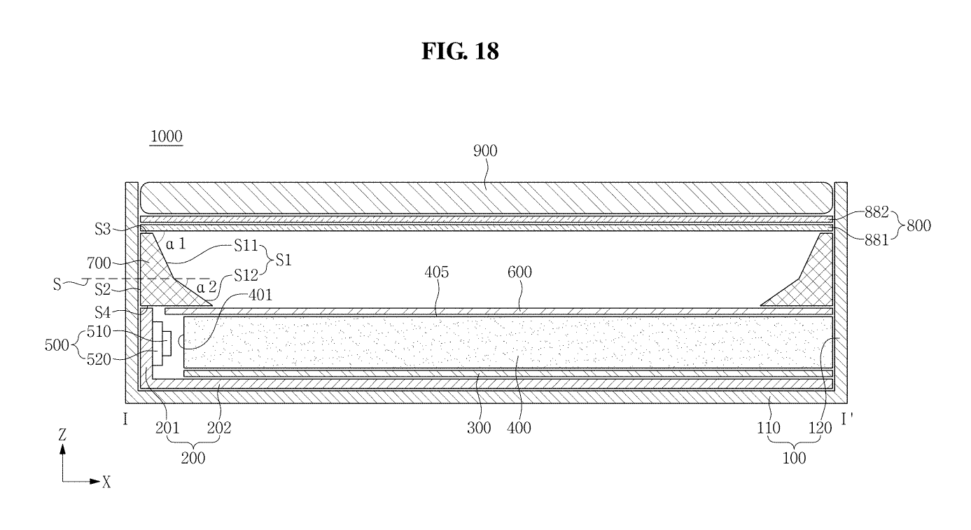

FIG. 17 is a view illustrating still another exemplary embodiment of a display device 1000 including a backlight unit according to the invention, and FIG. 18 is a cross-sectional view taken along line I-I′ of FIG. 17.

As illustrated in FIG. 18, a support frame 700 has an inner side surface S1, an outer side surface S2, an upper surface S3 and a lower surface S4. In such an exemplary embodiment, as illustrated in FIGS. 17 and 18, the inner side surface S1 of the support frame 700 may include at least two surfaces having different slopes. In an exemplary embodiment, for example, the inner side surface S1 may include a first surface S11 and a second surface S12 having different slopes.

An angle α1 between the first surface S11 and a first optical sheet 800 may be an acute angle. In an exemplary embodiment, for example, the angle α1 between the first surface S11 and the first optical sheet 800 may be in a range from about 60 degrees to about 80 degrees. As a more specific example, the angle α1 may be in a range from about 65 degrees to about 70 degrees.

An angle α2 between the second surface S12 and the first optical sheet 800 may be an acute angle. In an exemplary embodiment, for example, when defining a hypothetical plane S that passes through an intersection of the first surface S11 and the second surface S12 and is parallel to the first optical sheet 800 (e.g., an XY plane), the angle α2 between the hypothetical plane S and the second surface S12 may be an acute angle. In an exemplary embodiment, for example, the angle α2 between the second surface S12 and the hypothetical plane S may be in a range from about 60 degrees to about 80 degrees. As a more specific example, the angle α2 may be in a range from about 65 degrees to about 70 degrees.

An angle between the first surface S11 and the second surface S12 may be an obtuse angle.

As illustrated in FIG. 18, the first surface S11 may have a longer length than a length of the second surface S12, which are shown in the cross-sectional view. Although not illustrated, in another exemplary embodiment, the first surface S11 and the second surface S12 may have a substantially same length. Alternatively, in still another exemplary embodiment, the first surface S11 may have a less length than a length of the second surface S12.

A bottom case 100, a heat dissipation plate 200, a reflective sheet 300, a light source module 500, a light guide plate 400, a second optical sheet 600, a first optical sheet 800 and a display panel 900 of FIG. 17 are substantially the same as the bottom case 100, the heat dissipation plate 200, the reflective sheet 300, the light source module 500, the light guide plate 400, the second optical sheet 600, the first optical sheet 800 and the display panel 900 of FIG. 1, respectively, and thus detailed descriptions thereof will make reference to FIG. 1 and the related descriptions thereof.

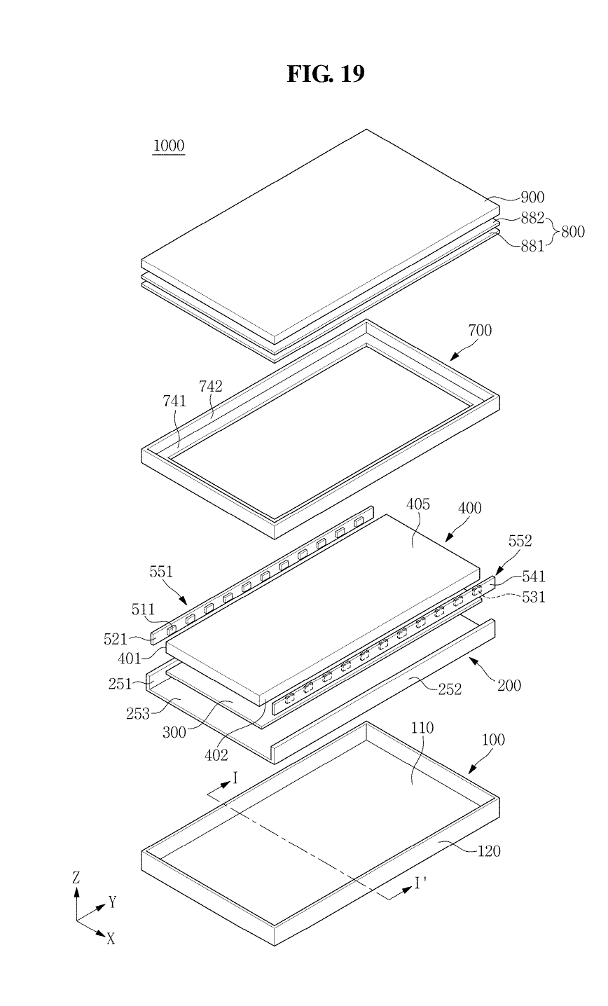

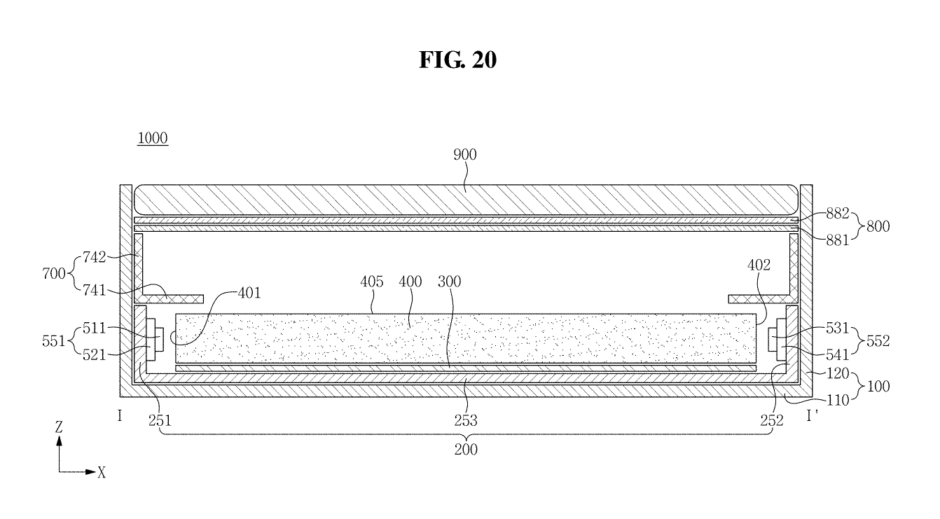

FIG. 19 is an exploded perspective view illustrating still another exemplary embodiment of a display device 1000 including a backlight unit according to the invention, and FIG. 20 is a cross-sectional view taken along line I-I′ of FIG. 19.

The display device 1000 according to an exemplary embodiment includes a bottom case 100, a heat dissipation plate 200, a reflective sheet 300, a first light source module 551, a second light source module 552, a light guide plate 400, a support frame 700, a first optical sheet 800 and a display panel 900, as illustrated in FIGS. 19 and 20.

The heat dissipation plate 200 of FIG. 19 emits heat generated from a first light source 511 of the first light source module 551 and a second light source 531 of the second light source module 552 outwards through the bottom case 100. To this end, at least a portion of the heat dissipation plate 200 may directly contact the first light source module 551, the second light source module 552, a base portion 110 and a side portion 120 of the bottom case 100.

The heat dissipation plate 200 may include a first heat dissipation portion 251, a second heat dissipation portion 252 and a third heat dissipation portion 253.

As illustrated in FIG. 20, a portion of the first heat dissipation portion 251 may be positioned between the first light source module 551 and the side portion 120 of the bottom case 100. The first heat dissipation portion 251 may contact the side portion 120. In an exemplary embodiment, for example, facing surfaces of the first heat dissipation portion 251 and the side portion 120 may directly contact each other.

As illustrated in FIG. 20, a portion of the second heat dissipation portion 252 may be positioned between the second light source module 552 and the side portion 120 of the bottom case 100. The second heat dissipation portion 252 may contact the side portion 120. In an exemplary embodiment, for example, facing surfaces of the second heat dissipation portion 252 and the side portion 120 may directly contact each other.

The third heat dissipation portion 253 may be positioned horizontally between the first heat dissipation portion 251 and the second heat dissipation portion 252. The third heat dissipation portion 253 is connected to an edge of the first heat dissipation portion 251 and an edge of the second heat dissipation portion 252. A portion of the third heat dissipation portion 253 may be positioned vertically between the base portion 110 of the bottom case 100 and the reflective sheet 300. The third heat dissipation portion 253 may contact the base portion 110. In an exemplary embodiment, for example, facing surfaces of the third heat dissipation portion 253 and the base portion 110 may directly contact each other.

A thickness of the first heat dissipation portion 251 may be greater than a thickness of the third heat dissipation portion 253. Herein, the thickness of the first heat dissipation portion 251 refers to the thickness in the X-axis direction and the thickness of the third heat dissipation portion 253 refers to the thickness in the Z-axis direction.

A thickness of the second heat dissipation portion 252 may be greater than a thickness of the third heat dissipation portion 253. Herein, the thickness of the second heat dissipation portion 252 refers to the thickness in the X-axis direction and the thickness of the third heat dissipation portion 253 refers to the thickness in the Z-axis direction.

The first heat dissipation portion 251 and the second heat dissipation portion 252 may have a substantially same thickness.

The heat dissipation plate 200 including the first heat dissipation portion 251, the second heat dissipation portion 252 and the third heat dissipation portion 253 may have a U-shaped cross-section as illustrated in FIG. 20. In an exemplary embodiment, the heat dissipation plate 200 may include a metal such as an aluminum material.

The first light source module 551 of FIG. 19 provides light. The first light source module 551 is positioned between the side portion 120 of the bottom case 100 and the first light incidence surface 401 of the light guide plate 400. In the case where the aforementioned heat dissipation plate 200 is included in the backlight unit, as illustrated in FIG. 20, the first light source module 551 may be positioned between the first heat dissipation portion 251 and the first light incidence surface 401 of the light guide plate 400.

The first light source module 551 may be affixed to the side portion 120 of the bottom case 100 or the first heat dissipation portion 251. In an exemplary embodiment, for example, in the case where the heat dissipation plate 200 is absent, the first light source module 551 may be affixed to an inner side surface of the side portion 120. Herein, the inner side surface of the side portion 120 refers to a surface of the side portion 120 that faces a first light incidence surface 401 of the light guide plate 400. In the case where the heat dissipation plate 200 is present, the first light source module 551 may be affixed to an inner side surface of the first heat dissipation plate 251. Herein, the inner side surface of the first heat dissipation plate 251 refers to a surface of the first heat dissipation plate 251 that faces the first light incidence surface 401 of the light guide plate 400.

The first light source module 551 may include a first printed circuit board 521 and at least one first light source 511, as illustrated in FIGS. 19 and 20. The specific configuration of the first light source module 551 will make reference to the light source module 500 of FIG. 1.

The second light source module 552 of FIG. 19 provides light. The second light source module 552 is positioned between the side portion 120 of the bottom case 100 and a second light incidence surface 402 of the light guide plate 400. In the case where the aforementioned heat dissipation plate 200 is included in the backlight unit, as illustrated in FIG. 20, the second light source module 552 may be positioned between the second heat dissipation portion 252 and the second light incidence surface 402 of the light guide plate 400.

The second light source module 552 may be affixed to the side portion 120 of the bottom case 100 or the second heat dissipation portion 252. In an exemplary embodiment, for example, in the case where the heat dissipation plate 200 is absent, the second light source module 552 may be affixed to an inner side surface of the side portion 120. Herein, the inner side surface of the side portion 120 refers to a surface of the side portion 120 that faces the second light incidence surface 402 of the light guide plate 400. In the case where the heat dissipation plate 200 is present, the second light source module 552 may be affixed to an inner side surface of the second heat dissipation plate 252. Herein, the inner side surface of the second heat dissipation plate 252 refers to a surface of the second heat dissipation plate 252 that faces the second light incidence surface 402 of the light guide plate 400.

The second light source module 552 may include a second printed circuit board 541 and at least one second light source 531, as illustrated in FIGS. 19 and 20. The specific configuration of the second light source module 552 will make reference to the light source module 500 of FIG. 1 described above.

The light guide plate 400 of FIG. 19 may have a polyhedral shape. A surface of the light guide plate 400 that faces the first light source 511 of the first light source module 551 is defined as the first light incidence surface 401 and a surface of the light guide plate 400 that faces the second light source 531 of the second light source module 552 is defined as the second light incidence surface 402, and a surface of the light guide plate 400 that faces toward the display panel 900 is defined as a light emission surface 405.

A light emitted from the first light sources 511 of the first light source module 551 is incident to the first light incidence surface 401 of the light guide plate 400. In addition, the light incident to the first light incidence surface 401 proceeds to the inside of the light guide plate 400.

The light guide plate 400 totally reflects the light that has entered the light guide plate 400 and guides the light outwards through the light emission surface 405. The light directed outwards through the light emission surface 405 passes through the first optical sheet 800 and is provided toward a display area of the display panel 900.

A light emitted from the second light sources 531 of the second light source module 552 is incident to the second light incidence surface 402 of the light guide plate 400. In addition, the light incident to the second light incidence surface 402 proceeds to the inside of the light guide plate 400. The light guide plate 400 totally reflects the light that has entered the light guide plate 400 and guides the light outwards through the light emission surface 405. The light directed outwards through the light emission surface 405 passes through the first optical sheet 800 and is provided toward the display area of the display panel 900.

Other detailed configurations of the light guide plate 400 of FIG. 19 will make reference to the light guide plate 400 of FIG. 1 described above.

Since the support frame 700 of FIG. 19 is substantially equal to the support frames 700 of FIGS. 14, 15 and 16 described above, thus the descriptions of the support frame 700 of FIG. 19 will make reference to FIGS. 14, 15 and 16 and the related descriptions thereof. However, the support frame 700 of FIG. 19 overlaps the first light source module 551, the second light source module 552, and an edge of the light guide plate 400.

The bottom case 100, the reflective sheet 300, the first optical sheet 800 and the display panel 900 of FIG. 19 are substantially the same as the bottom case 100, the reflective sheet 300, the first optical sheet 800 and the display panel 900 of FIG. 1, respectively, and thus detailed descriptions thereof will make reference to FIG. 1 and the related descriptions thereof.

The display device 1000 illustrated in FIGS. 19 and 20 includes the first light source module 551 and the second light source module 552 positioned on the opposite sides of the light guide plate 400, and thus the second optical sheet 600 may be omitted. The light from the first light source 511 included in the first light source module 551 may not sufficiently reach an edge portion (hereinafter, “a left edge portion”) of the display panel 900 positioned right above the first light source module 551 but the light from the second light source 531 included in the second light source module 552 may sufficiently reach the left edge portion. Similarly, the light from the second light source 531 included in the second light source module 552 may not sufficiently reach an edge portion (hereinafter, “a right edge portion”) of the display panel 900 positioned right above the second light source module 552 but the light from the first light source 511 included in the first light source module 551 may sufficiently reach the right edge portion.

This is because the light emitted from the first light source 511 of the first light source module 551 propagates with relatively high straightness toward the second light source module 552 and the light emitted from the light source 513 of the second light source module 552 propagates with relatively high straightness toward the first light source module 551. Accordingly, the left edge portion and the right edge portion of the display panel 900 may be supplied with sufficient light even without the second optical sheet 600.

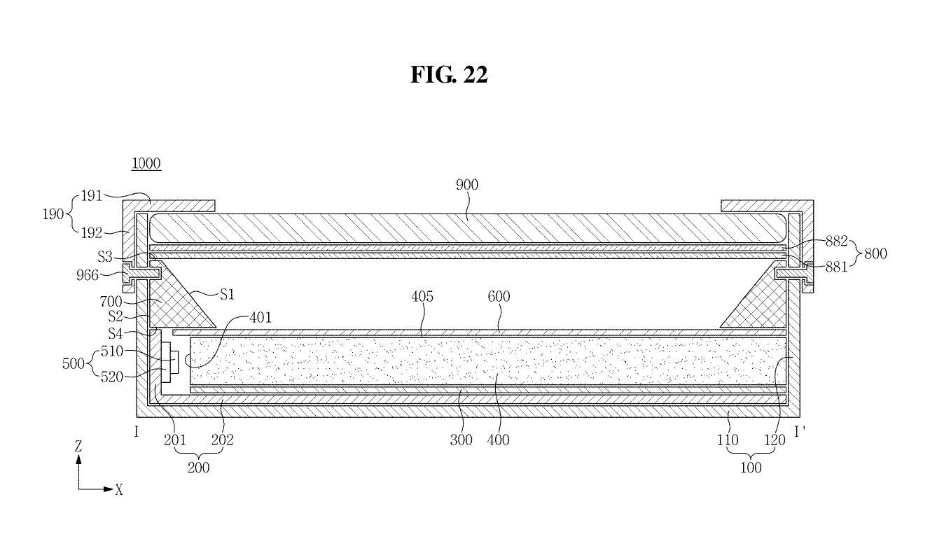

FIG. 21 is an view illustrating still another exemplary embodiment of a display device 1000 including a backlight unit according to the invention, and FIG. 22 is a cross-sectional view taken along line I-I′ of FIG. 21.

The display device 1000 may further include a top case 190, as illustrated in FIGS. 21 and 22.

The top case 190 has an opening that exposes a display area of a display panel 900, as illustrated in FIGS. 21 and 22. That is, the top case 190 has a quadrangular frame shape having an open center. The top case 190 covers an edge of the display panel 900 and a part of a side portion 120. To this end, the top case 190 includes an upper cover 191 covering the edge of the display panel 900 and a side cover 192 covering the part of the side portion 120.

Although not illustrated, the top case 190, a bottom case 100 and a support frame 700 may be coupled to each other by a coupling means 966. To this end, the top case 190 has a first coupling hole defined in the side cover 192, the bottom case 100 has a second coupling hole defined in the side portion 120, and the support frame 700 has a coupling groove. The coupling means 966 sequentially passes through the first coupling hole and the second coupling hole to be inserted to the coupling groove.

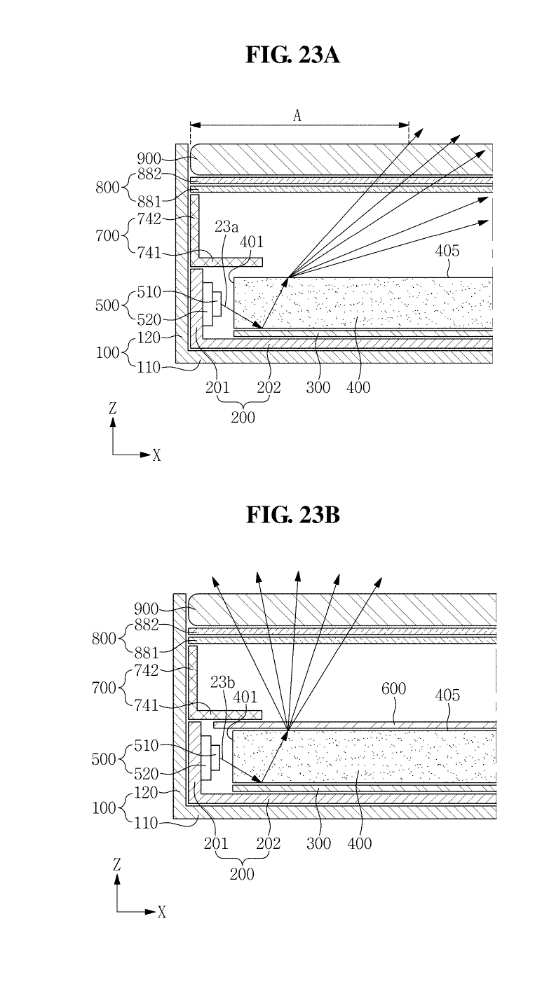

FIGS. 23A and 23B are explanatory views illustrating exemplary embodiments of optical paths depending on the presence of the second optical sheet 600.

As illustrated in FIG. 23A, in the case where a backlight unit does not include the second optical sheet 600, a light 23 a from the light source 510 may not sufficiently reach an edge portion A of the display panel 900 positioned right above the light source module 500. Accordingly, a dark portion may be generated at the edge portion A.

However, as illustrated in FIG. 23B, in the case where a backlight unit includes the second optical sheet 600, a light 23b from the light source 510 is scattered by the second optical sheet 600 and may sufficiently reach the edge portion A.

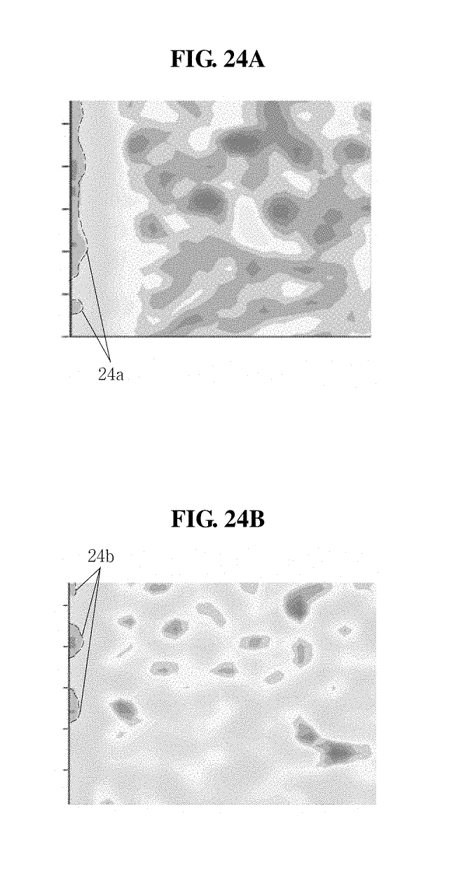

FIG. 24A is a view illustrating luminance distribution at the edge portion of the display panel 900 of FIG. 23A, and FIG. 24B is a view illustrating luminance distribution at the edge portion of the display panel 900 of FIG. 23B.

As illustrated in FIG. 24A, in the case where the backlight unit does not include the second optical sheet 600, a portion of a low luminance 24a is widely distributed at the edge portion A.

However, as illustrated in FIG. 24B, in the case where the backlight unit includes the second optical sheet 600, a portion of a low luminance 24b is relatively narrowly distributed at the edge portion A.

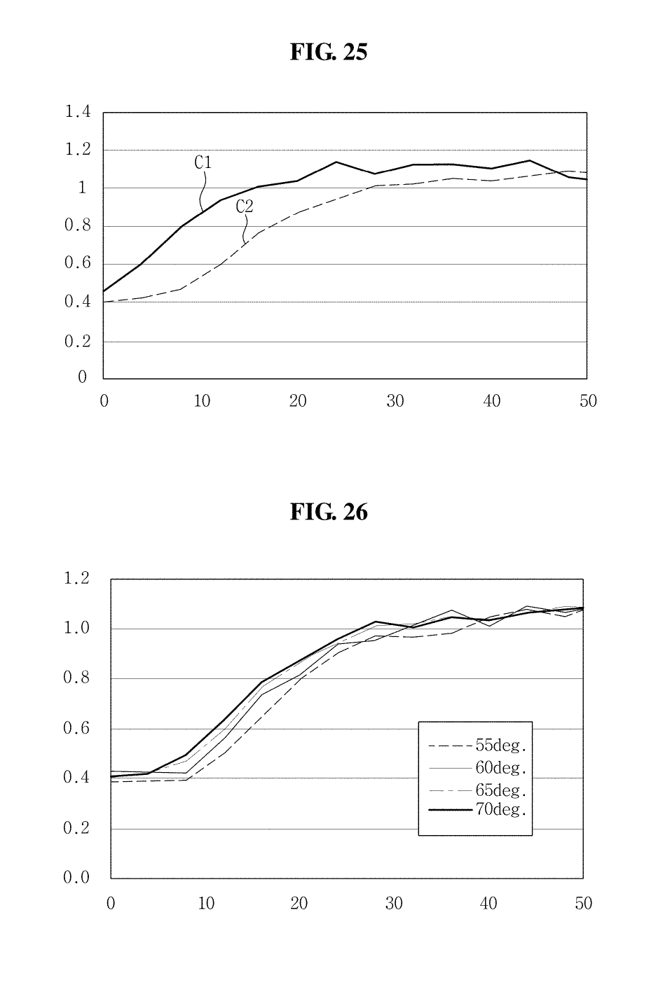

FIG. 25 is a graph showing luminance at the display panel 900 versus a distance from an edge of the display panel 900 of FIG. 23A and of FIG. 23B.

In FIG. 25, an X axis denotes a distance from the edge of the display panel 900 to a luminance measuring point and a Y axis denotes a luminance ratio. The luminance ratio refers to a ratio with respect to a predetermined reference luminance.

As illustrated in FIG. 25, a luminance curve C1 of the case where the backlight unit includes the second optical sheet 600 shows a higher luminance ratio than that of a luminance curve C2 of the case where the backlight unit does not include the second optical sheet 600.

FIG. 26 is a graph showing luminance at the display panel 900 depending on the angle θ2 between the inner side surface S1 and the lower surface S4 of the support frame 700 of FIG. 2 versus the distance from the edge of the display panel 900.

In FIG. 26, an X axis denotes a distance from the edge of the display panel 900 to a luminance measuring point and a Y axis denotes a luminance ratio. The luminance ratio refers to a ratio with respect to a predetermined reference luminance.

As illustrated in FIG. 2, the angle θ2 between the inner side surface S1 and the lower surface S4 of the support frame 700 is substantially equal to the angle θ1 between the inner side surface S1 of the support frame 700 and the first optical sheet 800. As the angle θ2 increases, a length of the lower surface S4 increases and a length of the outer side surface S2 decreases.

In the case where the angle θ2 is in a range from about 65 degrees to about 70 degrees, an optimum luminance ratio may be obtained.

FIG. 26 shows luminance curves when the angle θ2 is about 55 degrees, about 60 degrees, about 65 degrees and about 70 degrees.

As set forth hereinabove, the backlight unit according to one or more exemplary embodiments may provide the following effects.

The backlight unit according to one or more exemplary embodiments includes a light guide plate, a support frame and an optical sheet. In particular, the optical sheet is positioned between the support frame and the display panel. Accordingly, the backlight unit according to an exemplary embodiment has the structure of an edge-type backlight unit which is a structure including the light guide plate and the structure of a direct-type backlight unit which is a structure in which the optical sheet is positioned between the support frame and the display panel.

That is, the backlight unit according to one or more exemplary embodiments includes the light guide plate and thus may have a shorter optical distance than that of a conventional direct-type backlight unit. Accordingly, a display device including the backlight unit according to one or more exemplary embodiments may have a less thickness than a thickness of a display device including a conventional direct-type backlight unit.

In addition, the backlight unit according to an exemplary embodiment includes the support frame and thus may have a bezel area of a less width than a width of a conventional edge-type backlight unit.

While the invention has been illustrated and described with reference to the exemplary embodiments thereof, it will be apparent to those of ordinary skill in the art that various changes in form and detail may be made thereto without departing from the spirit and scope according to the invention.

What is claimed is:

1. A backlight unit comprising:
a support frame between a base portion of a bottom case and a display panel;
a light guide plate between the base portion of the bottom case and the support frame;
a light source between the light guide plate and a side portion of the bottom case which protrudes from the base portion of the bottom case; and
a first optical sheet between the support frame and the display panel.

2. The backlight unit as claimed in claim 1, further comprising a second optical sheet between the light guide plate and the support frame.

3. The backlight unit as claimed in claim 2, wherein the second optical sheet comprises:
a film;
a plurality of diffusers on the film, the plurality of diffusers having different refractive indices; and
an adhesive between the diffusers and the film and between adjacent ones of the diffusers.

4. The backlight unit as claimed in claim 3, wherein the plurality of diffusers has a sphere shape and different diameters.

5. The backlight unit as claimed in claim 2, wherein the second optical sheet comprises:
a film; and
a plurality of lens patterns on the film.

6. The backlight unit as claimed in claim 5, wherein at least one lens pattern of the plurality of lens patterns has a hemispherical shape or a triangular prism shape.

7. The backlight unit as claimed in claim 2, wherein the second optical sheet comprises:
a film; and
a plurality of diffusers in the film, the plurality of diffusers having different refractive indices.

8. The backlight unit as claimed in claim 2, wherein the second optical sheet comprises a quantum dot or a quantum rod.

9. The backlight unit as claimed in claim 1, wherein the first optical sheet comprises a plurality of sheets, each of the plurality of sheets being positioned at a different distance from the display panel from each other.

10. The backlight unit as claimed in claim 9, wherein at least one sheet of the plurality of sheets further comprises a fastening portion which protrudes from an edge of the at least one sheet and has a fastening hole.

11. The backlight unit as claimed in claim 10, wherein the at least one sheet includes a sheet that is adjacent to the support frame or the display panel among the plurality of sheets.

12. The backlight unit as claimed in claim 10, wherein the support frame comprises:
a fastening groove into which the fastening portion is inserted; and
a fastening projection inserted to the fastening hole of the fastening portion.

13. The backlight unit as claimed in claim 1, wherein an angle between an inner side surface of the support frame and the first optical sheet is an acute angle.

14. The backlight unit as claimed in claim 13, wherein an angle between the inner side surface of the support frame and the first optical sheet is from about 60 degrees to about 80 degrees.

15. The backlight unit as claimed in claim 13, wherein the support frame has a trapezoidal cross-section having one hypotenuse, and
an angle between the hypotenuse and the first optical sheet is the same as the angle between the inner side surface of the support frame and the first optical sheet.

16. The backlight unit as claimed in claim 1, wherein the support frame comprises:
a horizontal portion which overlaps the light source and an edge of the light guide plate; and
a vertical portion which protrudes from the horizontal portion toward the first optical sheet.

17. The backlight unit as claimed in claim 16, wherein the vetical portion, an overlap portion of the horizontal portion, which overlaps the vertical portion, and a non-overlap portion of the horizontal portion, which does not overlap the vertical portion, have different light transmittances.

18. The backlight unit as claimed in claim 17, wherein the non-overlap portion of the horizontal portion has a higher light transmittance than a light transmittance of the overlap portion of the horizontal portion.

19. The backlight unit as claimed in claim 1, wherein the support frame comprises a plurality of inner side surfaces having different slopes; and
an angle between each of the inner side surfaces and the first optical sheet is an acute angle.

20. The backlight unit as claimed in claim 1, wherein the support frame has a white color.
